(19) United States
(12) Patent Application Publication
(10) Pub. No.: US 2026/0235781 A1
(43) Pub. Date: Aug. 13, 2026

(54) SEISMIC IMAGING FRAMEWORK

(71) Applicant: SCHLUMBERGER TECHNOLOGY CORPORATION, Sugar Land, TX (US)

(72) Inventors: Bjarte DYSVIK, Stavanger (NO); Frode OIJORD, Stavanger (NO)

(21) Appl. No.: 19/137,329

(22) PCT Filed: Dec. 18, 2023
(86) PCT No.: PCT/US2023/084690

§ 371 Date: Jun. 10, 2025

Related U.S. Application Data
(60) Provisional application No. 63/477,342, filed on Dec. 27, 2022.

(51) Int. Cl. G01V 1/34; G06T 15/00; G06T 15/04; G06T 15/06

(52) U.S. Cl. CPC G01V 1/345; G06T 15/005; G06T 15/04; G06T 15/06

(57) ABSTRACT

A method can include initializing a visualization of volumetric seismic data using a computational framework, where the visualization includes a cuboid in a three-dimensional space for rendering as pixels in two-dimension to a display dimensions to a display according to a viewpoint, and where the visualization includes an opacity map; determining a front face of the cuboid and a back face of the cuboid from a perspective of the viewpoint; identifying bricks in a hierarchy of bricks of the volumetric seismic data for generation of a sparse texture for the visualization; and rendering the visualization to the display based on extending rays between the front face and the back face, sampling points on the rays, and associating the points with the sparse texture to provide values for the pixels of the visualization thresholded by the opacity map.

### RELATED APPLICATION

This application claims priority to and the benefit of a U.S. Provisional Application having Ser. No. 63/477,342, filed Dec. 27, 2022, which is incorporated by reference herein in its entirety.

### BACKGROUND

Reflection seismology finds use in geophysics to estimate properties of subsurface formations. Reflection seismology may provide seismic data representing waves of elastic energy as transmitted by P-waves and S-waves, in a frequency range of approximately 1 hertz (Hz) to approximately 100 Hz. In various instances, seismic data can also represent refractions and/or diving waves. Seismic data may be processed and interpreted to understand better composition, fluid content, extent and geometry of subsurface rocks. For example, a full-waveform inversion (FWI) may be implemented as part of a seismic data workflow for building a model of a subsurface environment where information from reflections, refractions and/or diving waves may be considered.

### SUMMARY

A method can include initializing a visualization of volumetric seismic data using a computational framework, where the visualization includes a cuboid in a three-dimensional space for rendering as pixels in two-dimensions to a display according to a viewpoint, and where the visualization includes an opacity map; determining a front face of the cuboid and a back face of the cuboid from a perspective of the viewpoint; identifying bricks in a hierarchy of bricks of the volumetric seismic data for generation of a sparse texture for the visualization; and rendering the visualization to the display based on extending rays between the front face and the back face, sampling points on the rays, and associating the points with the sparse texture to provide values for the pixels of the visualization thresholded by the opacity map. A system can include a processor; memory operatively coupled to the processor; and processor-executable instructions stored in the memory to instruct the system to: initialize a visualization of volumetric seismic data using a computational framework, where the visualization includes a cuboid in a three-dimensional space for rendering as pixels in two-dimensions to a display according to a viewpoint, and where the visualization includes an opacity map; determine a front face of the cuboid and a back face of the cuboid from a perspective of the viewpoint; identify bricks in a hierarchy of bricks of the volumetric seismic data for generation of a sparse texture for the visualization; and render the visualization to the display based on extension of rays between the front face and the back face, sampling points on the rays, and association of the points with the sparse texture to provide values for the pixels of the visualization thresholded by the opacity map. One or more computer-readable storage media can include computer-executable instructions executable to instruct a computing system to: initialize a visualization of volumetric seismic data using a computational framework, where the visualization includes a cuboid in a three-dimensional space for rendering as pixels in two-dimensions to a display according to a viewpoint, and where the visualization includes an opacity map; determine a front face of the cuboid and a back face of the cuboid from a perspective of the viewpoint; identify bricks in a hierarchy of bricks of the volumetric seismic data for generation of a sparse texture for the visualization; and render the visualization to the display based on extension of rays between the front face and the back face, sampling points on the rays, and association of the points with the sparse texture to provide values for the pixels of the visualization thresholded by the opacity map. Various other examples of methods, systems, devices, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a geologic environment;

FIG. 2 illustrates examples of survey techniques;

FIG. 3 illustrates examples of survey techniques;

FIG. 4 illustrates examples of survey techniques;

FIG. 5 illustrates an example of forward modeling and an example of inversion;

FIG. 6 illustrates an example of a method;

FIG. 7 illustrates an example of a computational framework;

FIG. 8 illustrates an example of a method and an example of a computing system;

FIG. 9 illustrates an example of a computational framework;

FIG. 10 illustrates examples of processes;

FIG. 11 illustrates examples of processes;

FIG. 12 illustrates an example of a computational framework; and

FIG. 13 illustrates components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

As mentioned, reflection seismology finds use in geophysics to estimate properties of subsurface formations. Reflection seismology can provide seismic data representing waves of elastic energy, as transmitted by P-waves and S-waves, in a frequency range of approximately 1 Hz to approximately 100 Hz or optionally less than 1 Hz and/or optionally more than 100 Hz. Seismic data may be processed and interpreted to understand better composition, fluid content, extent and geometry of subsurface rocks.

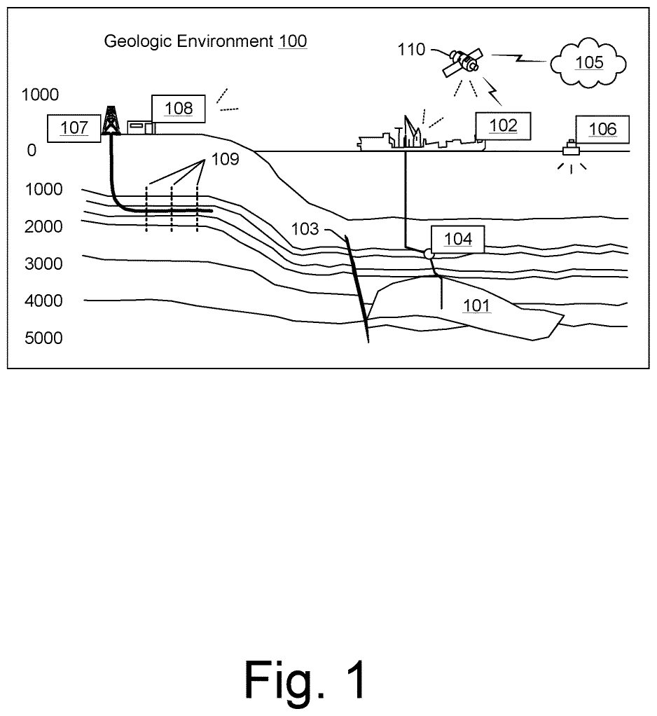

FIG. 1 shows a geologic environment 100 (an environment that includes a sedimentary basin, a reservoir 101, a fault 103, one or more fractures 109, etc.) and an example of an acquisition technique 140 to acquire seismic data (see data 160). A system may process data acquired by the technique 140 to allow for direct or indirect management of sensing, drilling, injecting, extracting, etc., with respect to the geologic environment 100. In turn, further information about the geologic environment 100 may become available as feedback (optionally as input to the system). An operation may pertain to a reservoir that exists in the geologic environment 100 such as the reservoir 101. A technique may provide information (as an output) that specifies one or more location coordinates of a feature in a geologic environment, one or more characteristics of a feature in a geologic environment, etc.

The geologic environment 100 may be referred to as a formation or may be described as including one or more formations. A formation may be a unit of lithostratigraphy such as a body of rock that is sufficiently distinctive and continuous.

A system may be implemented to process seismic data, optionally in combination with other data. Processing of data may include generating one or more seismic attributes, rendering information to a display or displays, etc. A process or workflow may include interpretation, which may be performed by an operator that examines renderings of information (to one or more displays, etc.) and that identifies structure or other features within such renderings. Interpretation may be or include analyses of data with a goal to generate one or more models and/or predictions (about properties and/or structures of a subsurface region).

A system may include features of a framework such as the PETREL seismic to simulation software framework (SLB, Houston, Texas). Such a framework can receive seismic data and other data and allow for interpreting data to determine structures that can be utilized in building a simulation model.

A system may include add-ons or plug-ins that operate according to specifications of a framework environment. As an example, a framework may be implemented within or in a manner operatively coupled to the DELFI cognitive exploration and production (E&P) environment (SLB, Houston, Texas), which is a secure, cognitive, cloud-based collaborative environment that integrates data and workflows with digital technologies, such as artificial intelligence and machine learning. As an example, such an environment can provide for operations that involve one or more frameworks.

Seismic data may be processed using a framework such as the OMEGA framework (SLB, Houston, TX). The OMEGA framework provides features that can be implemented for processing of seismic data through prestack seismic interpretation and seismic inversion.

A framework for processing data may include features for 2D line and 3D seismic surveys. Modules for processing seismic data may include features for prestack seismic interpretation (PSI), optionally pluggable into a framework such as the DELFI framework environment.

In FIG. 1, the geologic environment 100 includes an offshore portion and an on-shore portion. A geologic environment may be or include one or more of an offshore geologic environment, a seabed geologic environment, an ocean bed geologic environment, etc.

The geologic environment 100 may be outfitted with one or more of a variety of sensors, detectors, actuators, etc. Equipment 102 may include communication circuitry that receives and that transmits information with respect to one or more networks 105. Such information may include information associated with downhole equipment 104, which may be equipment to acquire information, to assist with resource recovery, etc. Other equipment 106 may be located remote from a well site and include sensing, detecting, emitting or other circuitry and/or be located on a seabed. Such equipment may include storage and communication circuitry that stores and that communicates data, instructions, etc. One or more satellites may be provided for purposes of communications, data acquisition, etc. FIG. 1 shows a satellite 110 in communication with the network 105 that may be configured for communications, noting that the satellite may additionally or alternatively include circuitry for imagery (spatial, spectral, temporal, radiometric, etc.).

FIG. 1 also shows the geologic environment 100 as optionally including equipment 107 and 108 associated with a well that includes a substantially horizontal portion that may intersect with one or more of the one or more fractures 109; consider a well in a shale formation that may include natural fractures, artificial fractures (hydraulic fractures) or a combination of natural and artificial fractures. The equipment 107 and/or 108 may include components, a system, systems, etc. for fracturing, seismic sensing, analysis of seismic data, assessment of one or more fractures, etc.

A system may be used to perform one or more workflows. A workflow may be a process that includes a number of worksteps. A workstep may operate on data to create new data, to update existing data, etc. A system may operate on one or more inputs and create one or more results based on one or more algorithms. A workflow may be a workflow implementable in the PETREL software that operates on seismic data, seismic attribute(s), etc. A workflow may be a process implementable in the DELFI environment, etc. A workflow may include one or more worksteps that access a plug-in (external executable code, etc.). A workflow may include rendering information to a display (a display device). A workflow may include receiving instructions to interact with rendered information to process information and optionally render processed information. A workflow may include transmitting information that may control, adjust, initiate, etc. one or more operations of equipment associated with a geologic environment (in the environment, above the environment, etc.).

As an example, an acquisition technique can be utilized to perform a seismic survey. A seismic survey can acquire various types of information, which can include various types of waves (e.g., P, SV, SH, etc.). A P-wave can be an elastic body wave or sound wave in which particles oscillate in the direction the wave propagates. P-waves incident on an interface (at other than normal incidence, etc.) may produce reflected and transmitted S-waves (e.g., “converted” waves). An S-wave or shear wave may be an elastic body wave in which particles oscillate perpendicular to the direction in which the wave propagates. S-waves may be generated by a seismic energy source (e.g., other than an air gun). S-waves may be converted to P-waves. S-waves tend to travel more slowly than P-waves and do not travel through fluids that do not support shear. Recording of S-waves involves use of one or more receivers operatively coupled to earth (e.g., capable of receiving shear forces with respect to time). Interpretation of S-waves may allow for determination of rock properties such as fracture density and orientation, Poisson's ratio and rock type by crossplotting P-wave and S-wave velocities, and/or by other techniques. Parameters that may characterize anisotropy of media (e.g., seismic anisotropy) include the Thomsen parameters ε, δ and γ.

Seismic data may be acquired for a region in the form of traces. For example, a technique can utilize a source for emitting energy where portions of such energy (e.g., directly and/or reflected) may be received via one or more sensors (e.g., receivers). Energy received may be discretized by an analog-to-digital converter that operates at a sampling rate. Acquisition equipment may convert energy signals sensed by a sensor to digital samples at a rate of one sample per approximately 4 milliseconds (ms). Given a speed of sound in a medium or media, a sample rate may be converted to an approximate distance. The speed of sound in rock may be of the order of around 5 kilometer (km) per second. Thus, a sample time spacing of approximately 4 ms would correspond to a sample “depth” spacing of about 10 meters (e.g., assuming a path length from source to boundary and boundary to sensor). A trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing scenario is divided by two (e.g., to account for reflection), for a vertically aligned source and sensor, the deepest boundary depth may be estimated to be about 10 km (e.g., assuming a speed of sound of about 5 km per second).

As mentioned, seismic data may be acquired and analyzed to understand better subsurface structure of a geologic environment. Reflection seismology finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz or optionally less than 1 Hz and/or optionally more than 100 Hz). Seismic data may be processed and interpreted, for example, to understand better composition, fluid content, extent and geometry of subsurface rocks.

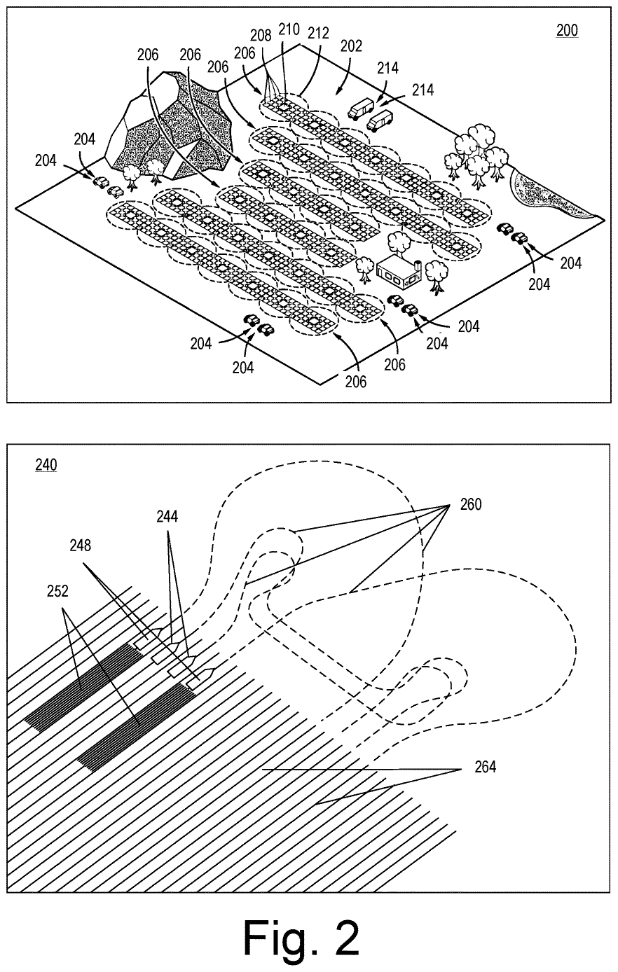

FIG. 2 shows an example of a simplified schematic view of a land seismic data acquisition system 200 and an example of a simplified schematic view of a marine seismic data acquisition system 240.

As shown with respect to the system 200, an area 202 to be surveyed may or may not have physical impediments to direct wireless communication between a recording station 214 (e.g., which may be a recording truck) and a vibrator 204. A plurality of vibrators 204 may be employed, as well as a plurality of sensor unit grids 206, each of which may have a plurality of sensor units 208.

As illustrated in FIG. 2 with respect to the system 200, approximately 24 to about 28 sensor units 208 may be placed in a vicinity (e.g., a region) around a base station 210. The number of sensor units 208 associated with each base station 210 may vary from survey to survey. Circles 212 indicate an approximate range of reception for each base station 210.

In the system 200 of FIG. 2, the plurality of sensor units 208 may be employed in acquiring and/or monitoring land-seismic sensor data for the area 202 and transmitting the data to the one or more base stations 210. Communications between the vibrators 204, the base stations 210, the recording station 214, and the seismic sensors 208 may be wireless (e.g., at least in part via air for a land-based system; or optionally at least in part via water for a sea-based system).

In the system 240 of FIG. 2, one or more source vessels 240 may be utilized with one or more streamer vessels 248 or a vessel or vessels may tow both a source or sources and a streamer or streamers 252. In the example of FIG. 2, the vessels 244 and 248 (e.g., or just the vessels 248 if they include sources) may follow predefined routes (e.g., paths) for an acquisition geometry that includes inline and crossline dimensions. As shown, routes 260 can be for maneuvering the vessels to positions 264 as part of the survey. As an example, a marine seismic survey may call for acquiring seismic data during a turn (e.g., during one or more of the routes 260).

The example systems 200 and 240 of FIG. 2 demonstrate how surveys may be performed according to an acquisition geometry that includes dimensions such as inline and crossline dimensions, which may be defined as x and y dimensions in a plane or surface where another dimension, z, is a depth dimension. As explained, time can be a proxy for depth, depending on various factors, which can include knowing how many reflections may have occurred as a single reflection may mean that depth of a reflector can be approximated using one-half of a two-way traveltime, some indication of the speed of sound in the medium and positions of the receiver and source (e.g., corresponding to the two-way traveltime).

Two-way traveltime (TWT) can be defined as the elapsed time for a seismic wave to travel from its source to a given reflector and return to a receiver (e.g., at a surface, etc.). As an example, a minimum two-way traveltime can be defined to be that of a normal-incidence wave with zero offset.

As an example, a seismic survey can include points referred to as common midpoints (CMPs). In multichannel seismic acquisition, a CMP is a point that is halfway between a source and a receiver that is shared by a plurality of source-receiver pairs. In such a survey, various angles may be utilized that may define offsets (e.g., offsets from a CMP, etc.). In a CMP approach, redundancy among source-receiver pairs can enhance quality of seismic data, for example, via stacking of the seismic data. A CMP can be vertically above a common depth point (CDP), or common reflection point (CRP). As an example, seismic data may be presented as a gather, which can be an image of seismic traces that share an acquisition parameter, such as a common midpoint gather (CMP gather or CMG), which contains traces having a common midpoint (CMP). In such an example, a CMG may be presented with respect to a horizontal dimension and a time dimension, which may be a TWT dimension.

As an example, a seismic survey can include points referred to as downward reflection points (DRPs). A DRP is a point where seismic energy is reflected downwardly. For example, where multiple interfaces exist, seismic energy can reflect upwardly from one interface, reach a shallower interface and then reflect downwardly from the shallower interface.

As an example, a seismic survey may be an amplitude variation with offset (AVO) survey. Such a survey can record variation in seismic reflection amplitude with change in distance between position of a source and position of a receiver, which may indicate differences in lithology and fluid content in rocks above and below a reflector.

AVO analysis can allow for determination of one or more characteristics of a subterranean environment (e.g., thickness, porosity, density, velocity, lithology and fluid content of rocks, etc.). As an example, gas-filled sandstone might show increasing amplitude with offset; whereas, a coal might show decreasing amplitude with offset. AVO analysis can be suitable for young, poorly consolidated rocks, such as those in the Gulf of Mexico.

As an example, a method may be applied to seismic data to understand better how structural dip may vary with respect to offset and/or angle as may be associated with emitter-detector (e.g., source-receiver) arrangements of a survey, for example, to estimate how suitable individual offset/angle gathers are for AVO imaging. As explained, a gather may be a collection of seismic traces that share an acquisition parameter, such as a common midpoint (CMP), with other collections of seismic traces. For example, consider an AVO survey that includes a plurality of emitter-detector arrangements (e.g., source-receiver pairs) with corresponding angles defined with respect to a common midpoint (CMP). Given a CMP, acquired survey data may be considered to cover a common subsurface region (e.g., a region that includes the midpoint).

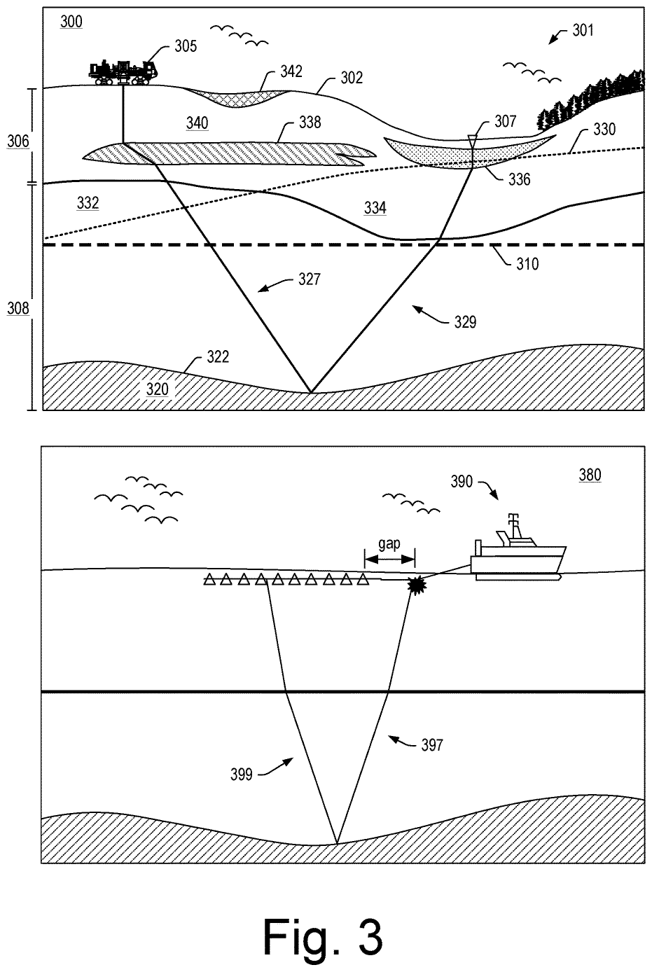

FIG. 3 shows an example of a land system 300 and an example of a marine system 380. The land system 300 is shown in a geologic environment 301 that includes a surface 302, a source 305 at the surface 302, a near-surface zone 306, a receiver 307, a bedrock zone 308 and a datum 310 where the near-surface zone 306 (e.g., near-surface region) may be defined at least in part by the datum 310, which may be a depth or layer or surface at which data above are handled differently than data below. For example, a method can include processing seismic data that aims to “place” the source 305 and the receiver 307 on a datum plane defined by the datum 310 by adjusting (e.g., “correcting”) traveltimes for propagation through the near-surface region (e.g., a shallower subsurface region).

In the example system 300 of FIG. 3, the geologic environment 301 can include various features such as, for example, a layer 320 that defines an interface 322 that can be a reflector, a water table 330, a leached zone 332, a glacial scour 334, a buried river channel 336, a region of material 338 (e.g., ice, evaporates, volcanics, etc.), a high velocity zone 340, and a region of material 342 (e.g., Eolian or peat deposits, etc.).

In FIG. 3, the land system 300 is shown with respect to downgoing rays 327 (e.g., downgoing seismic energy) and upgoing rays 329 (e.g., upgoing seismic energy). As illustrated the rays 327 and 329 pass through various types of materials and/or reflect off of various types of materials.

Various types of seismic surveys can contend with surface unevenness and/or near-surface heterogeneity. For example, a shallow subsurface can include large and abrupt vertical and horizontal variations that may be, for example, caused by differences in lithology, compaction cementation, weather, etc. Such variations can generate delays or advances in arrival times of seismic waves passing through them relative to waves that do not. By accounting for such time differences, a seismic image may be of enhanced resolution with a reduction in false structural anomalies at depth, a reduction in mis-ties between intersecting lines, a reduction in artificial events created from noise, etc.

As an example, a method can include adjusting for such time differences by applying a static, or constant, time shift to a seismic trace where, for example, applying a static aims to place a source and receiver at a constant datum plane below a near-surface zone. As an example, an amount by which a trace is adjusted can depend on one or more factors (e.g., thickness, velocity of near-surface anomalies, etc.).

In FIG. 3, the datum 310 is shown, for example, as a plane, below which strata may be of particular interest in a seismic imaging workflow. In a three-dimensional model of a geologic environment, a near surface region may be defined, for example, at least in part with respect to a datum. As an example, a velocity model may be a multidimensional model that models at least a portion of a geologic environment.

In the example of FIG. 3, the source 305 can be a seismic energy source such as a vibrator. As an example, a vibrator may be a mechanical source that delivers vibratory seismic energy to the Earth for acquisition of seismic data. As an example, a vibrator may be mounted on a vehicle (e.g., a truck, etc.). As an example, a seismic source or seismic energy source may be one or more types of devices that can generate seismic energy (e.g., an air gun, an explosive charge, a vibrator, etc.).

Vibratory seismic data can be seismic data whose energy source is a vibrator that may use a vibrating plate to generate waves of seismic energy. As an example, the frequency and the duration of emitted energy can be controllable, for example, frequency and/or duration may be varied according to one or more factors (e.g., terrain, type of seismic data desired, etc.).

As an example, a vibrator may emit a linear sweep of a duration that is of the order of seconds (e.g., at least seven seconds, etc.), for example, beginning with high frequencies and decreasing with time (downsweeping) or going from low to high frequency (upsweeping). As an example, frequency may be changed (e.g., varied) in a nonlinear manner (e.g., certain frequencies are emitted longer than others, etc.). In various vibrator scenarios, resulting source wavelet can be one that is not impulsive. As an example, parameters of a vibrator sweep can include start frequency, stop frequency, sweep rate and sweep length.

As an example, a vibrator may be employed in land acquisition surveys for areas where explosive sources may be contraindicated (e.g., via regulations, etc.). As an example, more than one vibrator can be used simultaneously (e.g., in an effort to improve data quality, etc.).

As an example, a receiver may be a may be a UNIQ sensor unit (SLB, Houston, Texas). As an example, a sensor unit can include a geophone, which may be configured to detect motion in a single direction. As an example, a geophone may be configured to detect motion in a vertical direction. As an example, three mutually orthogonal geophones may be used in combination to collect so-called 3C seismic data. As an example, a sensor unit that can acquire 3C seismic data may allow for determination of type of wave and its direction of propagation. As an example, a sensor assembly or sensor unit may include circuitry that can output samples at intervals of 1 ms, 2 ms, 4 ms, etc. As an example, an assembly or sensor unit can include an analog to digital converter (ADC) such as, for example, a 24-bit sigma-delta ADC (e.g., as part of a geophone or operatively coupled to one or more geophones). As an example, a sensor assembly or sensor unit can include synchronization circuitry such as, for example, GPS synchronization circuitry with an accuracy of about plus or minus 12.5 microseconds. As an example, an assembly or sensor unit can include circuitry for sensing of real-time and optionally continuous tilt, temperature, humidity, leakage, etc. As an example, an assembly or sensor unit can include calibration circuitry, which may be self-calibration circuitry.

In FIG. 3, the system 380 includes equipment 390, which can be a vessel that tows one or more sources and one or more streamers (e.g., with receivers). In the system 380, a source of the equipment 390 can emit energy at a location and a receiver of the equipment 390 can receive energy at a location. The emitted energy can be at least in part along a path of the downgoing energy 397 and the received energy can be at least in part along a path of the upgoing energy 399.

In various systems, for one or more reasons, a gap in coverage may exist. For example, in the system 380 a gap is identified and labeled where the gap may be defined as a distance between a seismic source and a seismic receiver. In such an example, the distance may be considered a practical or a safe distance for locating a seismic receiver from a seismic source. If a seismic receiver is too close to a seismic source, the seismic receiver may experience a rather large shock wave and/or may otherwise experience energy that may be quite high and raise concerns with calibration, dynamic range, etc.

In the examples of FIG. 3, the paths are illustrated as single reflection paths for sake of simplicity. In the environments illustrated, additional interactions, reflections can be expected. For example, ghosts may be present. A ghost can be defined as a short-path multiple, or a spurious reflection that occurs when seismic energy initially reverberates upward from a shallow subsurface and then is reflected downward, such as at the base of weathering or between sources and receivers and the sea surface. As an example, the equipment 390 can include a streamer that is configured to position receivers a distance below an air-water interface such that ghosts can be generated where upgoing energy impacts the air-water interface and then reflects downward to the receivers. In such an example, a process may be applied that aims to “deghost” seismic data. Deghosting can be applied to marine seismic survey data where such a process aims to attenuate signals that are downgoing from an air-water interface (e.g., a sea surface interface). As mentioned, one or more other techniques, technologies, etc., may be utilized for seismic surveying (e.g., ocean bottom cables, ocean bottom nodes, etc.).

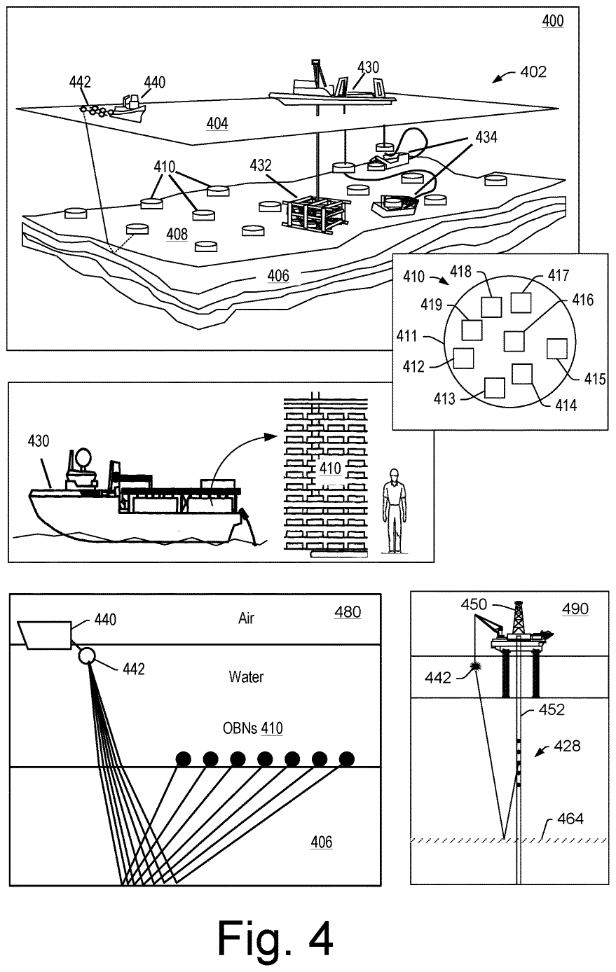

FIG. 4 shows a system 400 for acquisition of information in a geologic environment 402 that includes an air-water surface 404, a formation 406 and a seabed 408 (e.g., water-bed interface) where nodes 410 are positioned on the seabed 408. Equipment may be utilized to position the nodes 410 on the seabed 404 and retrieve the nodes 410 from the seabed 404. Such equipment may include one or more vessels 430, one or more carriers 432 and one or more vehicles 434, which may be autonomous, semi-autonomous, etc. (e.g., remotely operated vehicles (ROVs), etc.). The system 400 may include a seismic source vessel 440 that includes one or more seismic sources 442. The seismic source vessel 440 may travel a path while, at times, emitting seismic energy from the one or more sources 442. In such an approach, the nodes 410 can receive portions of the seismic energy, which can include portions that have travelled through the formation 406. Analysis of received seismic energy by the nodes 410 may reveal features of the formation 406.

In FIG. 4, the vessel 430 is shown as including nodes 410 as cargo arranged on racks. The nodes 410 can be deployed to form an array, for example, according to a survey plan. An array of nodes may be cabled or un-cabled. A cable may be relatively light weight and utilized to deploy a node receiver line with nodes coupled to the cable at spaced intervals. A rack can be utilized to securely store nodes in slots along multiple rows and columns. An individual slot may include a communications portal that can establish communication via contact(s) and/or contactless/wireless with an individual node seated in the individual slot for download of information, etc. A rack can include charger circuitry that can charge one or more batteries of an individual node seated in an individual slot. A node can be sealed such that components (e.g., circuitry, one or more batteries, etc.) are not exposed to water when the node is deployed on an underwater bed. A seal may be a hermetic seal that aims to prevent passage of air and/or water. A seal or seals can aim to prevent intrusion of water from an exterior region to an interior region of a node. Such a node can be considered to be water-tight. A sealed node can be a self-contained piece of equipment that can sense information independent of other equipment when positioned on an underwater surface that may be a seabed.

A rack may be dimensioned in accordance with shipping container dimensions such as about 3 meters by about 7 meters by about 3 meters. As shown in FIG. 4, with reference to a silhouette of a person that is about 1.8 meters in height, a node may be about a meter or less in diameter and about half a meter in height or less.

In FIG. 4, the one or more sources 442 may be an air gun or air gun array (e.g., a source array). A source can produce a pressure signal that propagates through water into a formation where acoustic and elastic waves are formed through interaction with features (e.g., structures, fluids, etc.) in the formation. Acoustic waves can be characterized by pressure changes and a particle displacement in a direction of which the acoustic wave travels. Elastic waves can be characterized by a change in local stress in material and a particle displacement. Acoustic and elastic waves may be referred to as pressure and shear waves, respectively; noting that shear waves may not propagate in water. Collectively, acoustic and elastic waves may be referred to as a seismic wavefield.

Material in a formation may be characterized by one or more physical parameters such as density, compressibility, and porosity. In the geologic environment 402 of FIG. 4, energy emitted from the one or more sources 442 can be transmitted to the formation 406; however, elastic waves that reach the seabed 408 will not propagate back into the water. Such elastic waves may be received by sensors of the nodes 410. The nodes 410 can include motion sensors that can measure one or more of displacement, velocity and acceleration. A motion sensor may be a geophone, an accelerometer, etc. As to pressure waves, the nodes 410 can include pressure wave sensors such as hydrophones.

In FIG. 4, the nodes 410 can include sensors for acquiring seismic wavefield information at the seabed 408. Each of the nodes 410 can include one or more hydrophones and/or one or more motion sensors (e.g., one or more geophones, one or more accelerometers, etc.).

A node can include various types of circuitry. Such circuitry can include circuitry that can digitize (e.g., analog to digital conversion (ADC) circuitry) and can include circuitry that can record signals (e.g., a microcontroller, a processor, etc., operatively coupled to memory). Each of the nodes 410 can include a housing 411, sensors 412 and 413, one or more microcontrollers or processors 414, one or more batteries 415, memory 416, ADC circuitry 417, a compass 418, communication circuitry 419, etc. As an example, a node can include one or more clocks, which may be amenable to calibration, synchronization, etc. For example, consider synchronizing to a signal, calibrating against a value, etc. As an example, a node can provide for receiving seismic energy and generating digital data that can be coded or otherwise stamped with information corresponding to time (e.g., according to one or more clocks). Various components of a node may be operatively coupled via wires, connectors, etc. A node can include one or more circuit boards (e.g., printed circuit boards, etc.) that can provide for electrical connections between various components, etc.

After deployment, one or more acoustic techniques may be utilized to determine node locations. A technique may employ acoustic pinging where acoustic pingers emit relatively high-frequency pings that are substantially above the maximum frequency of interest for seismic applications. Such relatively high-frequency acoustic signals can be picked up by one or more seismic sensors. Triangulation or one or more other techniques may be utilized to determine node locations for nodes deployed on an underwater surface such as a seabed.

Nodes may be utilized to acquire information spatially and temporally such as in a time-lapse seismic survey, which may be a four-dimensional seismic survey (e.g., a 4D seismic survey). A seismic image of a formation may be made for a first survey and a seismic image of the formation may be made for a second survey where the first and second surveys are separated by time (e.g., a lapse in time). In such an approach, a comparison of the images can infer changes in formation properties that may be tied to production of hydrocarbons, injection of water or gas, etc.

A first survey may be referred to as a baseline survey, while a subsequent survey may be referred to as a monitor survey. To minimize artifacts in differences between seismic images from successive lapses, a monitor survey may aim to replicate a configuration of a corresponding baseline survey. Where nodes are utilized at various positions on a seabed for a baseline survey, a monitor survey may aim to place nodes on the seabed in a manner that replicates the various positions of the nodes of the baseline survey. For the monitor survey, the nodes may be the same nodes, include some of the same nodes, include some different nodes or may be different nodes. A service may have a stock of nodes that can be utilized for various surveys where once a survey is complete, the nodes are retrieved, transported and positioned for another survey. Such a service may update, replace, etc., nodes from time to time.

A position to within a few meters of accuracy of one or more nodes may be determined via one or more of GPS, an acoustic positioning system (e.g., a short-baseline (SBL) or ultra-short baseline (USBL) acoustic system), and one or more other types of systems.

A node can include sensor circuitry for acquiring measurements of a seismic pressure wavefield and its gradient; consider sensor circuitry that can measure a seismic pressure wavefield and its gradient in vertical and crossline directions.

A node can include point-receiver circuitry. A point-receiver approach can combine hydrophones with tri-axial microelectromechanical system (MEMS) accelerometers. In such an approach, the MEMS accelerometers can measure a substantial bandwidth of particle acceleration due to seismic wavefields. Measurements of particle acceleration can be directly related to a gradient in a pressure wavefield. A node may include the ISOMETRIX technology, which includes point-receiver circuitry (SLB, Houston, Texas).

In the example of FIG. 4, one of the nodes 410 may be connected to one or more other nodes of the nodes 410 via a cable. A vessel may include a cable that is operatively coupled to at least one node. In the system 400 of FIG. 4, nodes may be deployed according to a survey plan in a grid pattern; consider placement of nodes on a seabed according to an x, y grid where distance between adjacent nodes may be of the order of hundreds of meters. As shown in the system 400, the seismic source vessel 440 may be employed with the one or more sources 442 that can emit energy, which can, in turn, be received via one or more of the nodes 410.

As an example, a common shot approach 480 may be utilized, as illustrated via the formation 406, the OBNs 410, the seismic source vessel 440 and the one or more sources 442. As explained, the vessel 440 can tow one or more sources at or below an air-water interface where the OBNs 410 can be positioned on a water-formation interface (e.g., a seafloor, seabed, ocean bottom, sea bottom, etc.). As shown, the energy of the source or the sources 442 passes through the water and then into the formation 406 where a portion of the energy is reflected at an interface (e.g., a reflector). As shown, energy can reflect off the interface and progress upwardly to the OBNs 410, which can be receivers that record the energy.

When seismic traces of a gather come from a single shot and many receivers, they can form a common shot gather; whereas, a single receiver with many shots can form a common receiver gather. A shot gather is a plot of traces with respect to line distance (e.g., an inline or a crossline series of receivers) with respect to time. Such a plot may be referred to as an image, which includes information about a subsurface region; noting that traces may be processed to generate one or more other types of images of a subsurface region.

Also shown in FIG. 4 is an inset of a zero-offset vertical seismic profile (VSP) scenario 490. In such a scenario, an acquisition geometry may be limited to an ability to position equipment that is physically coupled to a rig 450. As shown, for given the acquisition geometry, there may be no substantial offset between the source 442 and a bore 452. In such a scenario, a zero-offset VSP may be acquired where seismic waves travel substantially vertically down to a reflector (see the layer 464) and up to receivers 428, which may be a receiver array. Where one or more vessels are employed, one or more other types of surveys may be performed. A three-dimensional VSP may be performed using a vessel. As an example, a VSP may be performed using one or more nodes, etc.

Some examples of techniques that can process seismic data include migration and migration inversion, which may be implemented for purposes such as structural determination and subsequent amplitude analysis. In seismic exploration, signal can be defined as a part of a recorded seismic record (e.g., events) that is decipherable and useful for determining subsurface information (e.g., relevant to the location and production of hydrocarbons, etc.). Migration and migration inversion are techniques that can be used to extract subsurface information from seismic reflection data.

As an example, a migration technique can include predicting a coincident source and receiver at depth at a time equal to zero; an approach that may be extended for heterogeneous media and to accommodate two-way propagation in a local sense at points from the source to a target reflector and back from the reflector to the receiver and in a global sense, separately for each of the two legs from the source to the reflector and from the reflector to the receiver. Such an approach for two-way wave propagation migration may provide for quantitative and definitive definition of the roles of primaries and multiples in migration where, for example, migration of primaries can provide subsurface structure and amplitude information.

Various techniques that can be used to predict a wavefield inside a volume from (measured) values of a field on a surface surrounding the volume involve Green's theorem. Green's theorem may be implemented, for example, as part of a process for a finite volume model prediction of the so-called “source and receiver experiment” for two-way waves at depth. As an example, Green's theorem can predict a wavefield at an arbitrary depth z between a shallower depth “a” and a deeper depth “b”.

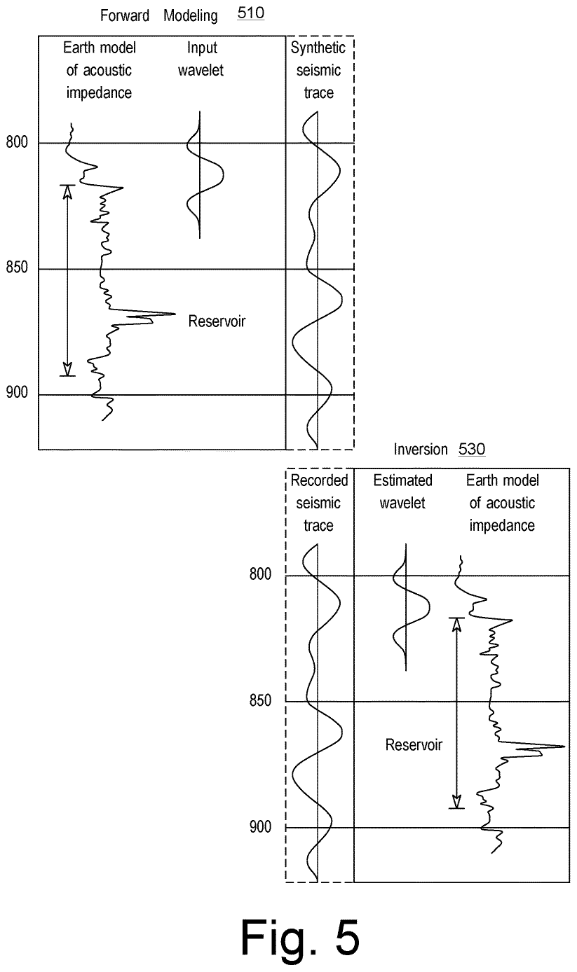

FIG. 5 shows an example of forward modeling 510 and an example of inversion 530 (e.g., an inversion or inverting). As shown, the forward modeling 510 progresses from an earth model of acoustic impedance and an input wavelet to a synthetic seismic trace while the inversion 530 progresses from a recorded seismic trace to an estimated wavelet and an Earth model of acoustic impedance. As an example, forward modeling can take a model of formation properties (e.g., acoustic impedance as may be available from well logs) and combine such information with a seismic wavelength (e.g., a pulse) to output one or more synthetic seismic traces while inversion can commence with a recorded seismic trace, account for effect(s) of an estimated wavelet (e.g., a pulse) to generate values of acoustic impedance for a series of points in time (e.g., depth).

Acoustic impedance is the opposition of a medium to a longitudinal wave motion. Acoustic impedance is a physical property whose change determines reflection coefficients at normal incidence, that is, seismic P-wave velocity multiplied by density. Acoustic impedance characterizes the relationship between the acting sound pressure and the resulting particle velocity.

During the propagation of seismic wave along a ray path, a seismic wave transmits through or reflects at a material boundary and/or converts its vibration mode between P-wave and S-wave. An observed amplitude of a seismic wave depends on an acoustic impedance contrast at a material boundary between an upper medium and a lower medium. Acoustic impedance, Z, can be defined by a multiplication of density, p, and seismic velocity, Vp, in each media. Acoustic impedance Z tends to be proportional to Vp for the many sedimentary and crustal rocks (e.g., granite, anorthite, pyrophyllite, and quartzite), except for some ultramafic rocks (e.g., dunite, eclogite, and peridotite) in the mantle.

In various instances, an inversion problem may be ill-posed for one or more reasons. Recorded data can include discrepancies including, for example, missing near offsets (e.g., due to gaps, etc.), and multiple events with other artifacts that contaminate the model of primaries that is inverted for. Artifacts can also be associated with inversion inaccuracies coming from inaccurate physics simulation (e.g., inversion of 3D data using 2D inversion, wavelet estimation errors, etc.).

For various reasons, a seismic survey may have coverage issues. For example, certain subsurface structures may impact “illumination” of one or more regions by seismic energy. In seismology, illumination can refer to an ability for seismic energy to fall on a reflector and thus be available to be reflected. Illumination can depend on source-receiver configuration (e.g., a survey geometry) and velocity distribution such as, for example, irregular velocity contrasts that may bend raypaths differently than adjacent raypaths. Various regions can have complicated velocity variations, for example, consider high-velocity contrast regions and subsalt regions.

A subsalt region can be an exploration and production play type in which prospects exist below salt layers. Prospecting for such regions below salt layers can pose challenges with respect to illumination, which may result in seismic data of poor quality. The Gulf of Mexico includes subsalt-producing fields; noting that subsalt regions also exist in other parts of the world such as, for example, offshore Brazil in the Santos, Campos and Espirito Santo basins.

A region below salt (e.g., a subsalt region) may be referred to as a pre-salt layer. As an example, a region may include a diachronous series of geological formations on a continental shelve of an extensional basin formed after the break-up of Gondwana, which may be characterized by deposition of thick layers of evaporites that can be composed mostly of salt. In various regions, some petroleum generated from sediments in a pre-salt layer may not have migrated upward to post-salt layers above, for example, due to one or more salt domes. Such types of regions exist off the coast of Africa and the coast of Brazil. Total pre-salt hydrocarbon reserves are estimated to be a substantial fraction of the world's hydrocarbon reserves.

Off the coast of Brazil, oil and natural gas reserves lie below an approximately 2,000 meters (m) (6,600 feet (ft)) thick layer of salt, which in turn is beneath more than 2,000 m (6,600 ft) of post-salt sediments in places, which in turn is under water depths between 2,000 m and 3,000 m (6,600 ft and 9,800 ft) in the South Atlantic. Drilling through rock and salt to extract pre-salt oil and gas can be complicated and costly. As explained, seismic surveying can be challenging in such regions, which can introduce uncertainties in planning, drilling, etc.

A 3D seismic dataset can be referred to as a cube or volume of data; a 2D seismic data set can be referred to as a panel of data. To interpret 3D data, processing can be on the “interior” of the cube, which tends to be an intensive computation process because massive amounts of data are involved. For example, a 3D dataset can range in size from a few tens of megabytes to several terabytes or more.

A 3D seismic data volume can include a vertical axis that is two-way traveltime (TWT) rather than depth and can include data values that are seismic amplitudes values. Such data may be defined at least in part with respect to a time axis where a trace may be a data vector of values with respect to time.

Acquired field data may be formatted according to one or more formats. For example, consider a well data format AAPG-B, log curve formats LAS or LIS-II, seismic trace data format SEGY, shotpoint locations data formats SEGP1 or UKOOA and wellsite data format WITS.

As to SEGY, which may be referred to as SEG-Y or SEG Y, it is a file format developed by the Society of Exploration Geophysicists (SEG) for storing geophysical data. It is an open standard, and is controlled by the SEG Technical Standards Committee, a non-profit organization. The format was originally developed in 1973 to store single-line seismic reflection digital data on magnetic tapes. The most recent revision of the SEG-Y format was published in 2017, named the rev 2.0 specification and includes certain legacies of the original format (referred as rev 0), such as an optional SEG-Y tape label, the main 3,200-byte textual EBCDIC character encoded tape header and a 400-byte binary header.

A format referred to as ZGY (or zgy) is a file format that can be used for storing 3D seismic trace data. Data may be converted to ZGY from SEG-Y format. The ZGY format supports compression of data. ZGY uses bricking to store multiple resolutions of a dataset. As an example, a brick may include 64×64×64 samples, though brick sizes can vary. ZGY can be a compressed format of the SEG-Y data such that the ZGY format demands less storage space, where ZGY format data may be readily exchangeable. As an example, a compressed brick may be 4×4×4 and may be referred to as a micro-brick (e.g., where a 64×64×64 brick may be referred to as a macro-brick).

As an example, a method may provide for decoupling brick size for compression and the brick size for random access in a particular format (e.g., consider the OPENZGY (or OPEN ZGY) format (see, e.g., Open Subsurface Data Universe (OSDU) group of open-source projects, which includes an OPENZGY software development toolkit (SDK)). As an example, a random-access macro-brick size may be set by default, for example, to 64×64×64 samples; noting that one or more other sizes may be specified and/or utilized. As an example, a compression brick size may be smaller such as, for example, 4×4×4 samples. As an example, a full 3D seismic volume may be, by default, partitioned into a set of 64×64×64 sample sub-cubes (bricks or macro-bricks), which in turn is partitioned into a set of 4×4×4 sample bricks (e.g., micro-bricks). In such an example, micro-bricks may be compressed individually and independently of each other, whether in series and/or in parallel.

As an example, one or more of various formats may be utilized for seismic data, for example, for storage, processing, transmission, rendering, etc.

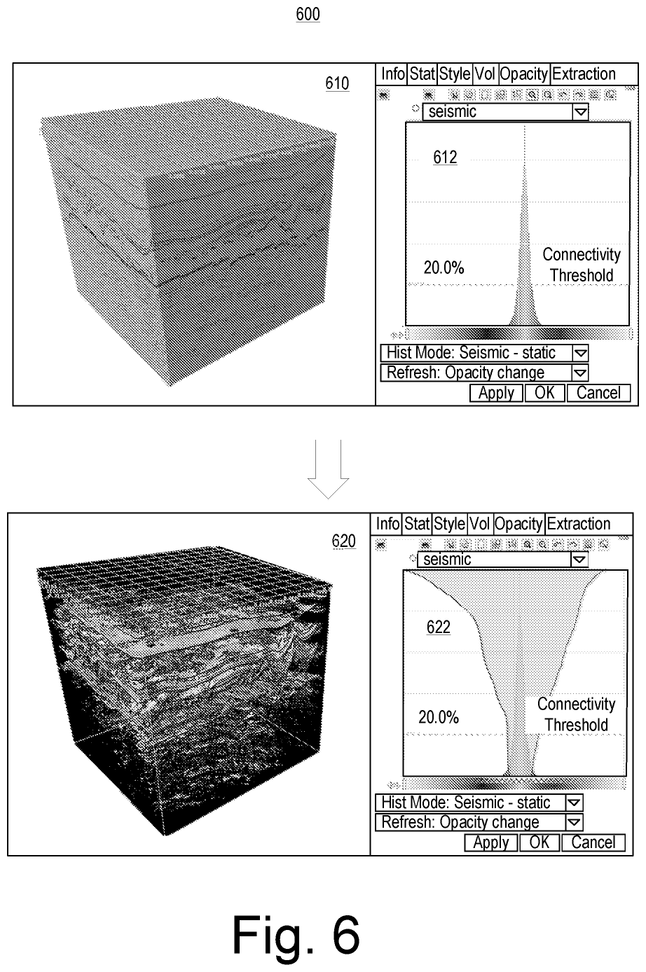

FIG. 6 shows an example of a method 600 that can be implemented during an interpretation workflow using seismic data from one or more seismic surveys. As shown, the method 600 can include rendering a visualization of seismic data to a 2D display where the visualization is in 3D coordinates in a seismic data space. As explained, events may be discerned in seismic data where such events can be associated with reflectors where seismic energy is at least in part reflected. For example, in geophysics, a reflector can be an interface between layers of contrasting acoustic, optical or electromagnetic properties. Waves of electromagnetism, heat, light and sound can be reflected at such an interface. In seismic data, a reflector might represent a change in lithology, a fault or an unconformity. A reflector can be expressed as a reflection in seismic data. An event can be defined as an appearance of seismic data as a diffraction, reflection, refraction or other similar feature produced by an arrival of seismic energy. An event can be a single wiggle within a trace, or a consistent lining up of several wiggles over several traces. An event in a seismic section can represent a geologic interface, such as a fault, unconformity or change in lithology.

In the example of FIG. 6, the method 600 includes rendering a visualization 610 along with a histogram 612, which can be a histogram distribution of values within voxels of a seismic cube (e.g., volumetric seismic data) where each voxel can represent a single value in the seismic cube. As events (e.g., reflector events, etc.) may be relatively sparse, volume-wise, within a seismic cube, many values can be within a middle range of the histogram 612. As explained, wiggles, which may be changes in amplitude due to an event, can be sparse and, for example, represented as being at tail portions of a distribution (e.g., tail portions of the histogram 612, that extend to the left and to the right). In the visualization 610, the volume represented is opaque as all of the values of the histogram 612 are rendered. As an example, a method can include moving a slice through the visualization 610 such that internal structures of the volume may be discerned at various positions. However, an alternative to using a slice (e.g., a plane), can be to use only a portion of the values of the histogram 612.

In the example of FIG. 6, a visualization 620 is generated by altering the values of voxels to be rendered, for example, by setting opacity and/or transparency of the histogram 612 to generate the modified histogram 622. Such an approach may be considered a type of filtering, which may be linear, nonlinear, etc. In the example of FIG. 6, the histogram 622 chops out the middle portion and maintains the tails (e.g., end portions), which are likely to include values representative of wiggles, etc. The visualization 620 allows for seeing into the volume such that various geologic structures can be discerned. For example, the structures can include horizons, geobodies, etc., which may give insights into the presence and/or location of hydrocarbons in the region that was imaged via one or more seismic surveys.

In the example of FIG. 6, the visualizations 610 and 620 are both examples of results from volume rendering, which can be defined as a set of techniques used to display a 2D projection of a 3D discretely sampled data set, which may be, for example, a 3D scalar field.

Various types of seismic volume workflows demand access to seismic volume data structures to provide for visualization. The size of a seismic volume can be substantial and demand considerable resources and/or time for access, processing, transmission, rendering, etc. Thus, size can be an impediment to a workflow. For example, where a user aims to interpret a geologic region, the user may find that data-related processes slow down interactivity, which may cause the user to operate in a manner that is based on such processes as rate determining. In such an approach, the user may lose focus, concentration, etc., as more opportunities arise for interruptions, distractions, etc. For example, consider a user calling for a seismic data visualization where the user is to visually identify a feature. In such a situation, the user may have to wait a considerable amount of time for a call and response, and rendering, to occur for the visualization at a desired level of resolution. Waiting can therefore be a nuisance, which may wear on an interpreter and decrease the interpreter's productivity and enjoyment.

As mentioned, a seismic volume can be greater than several gigabytes and may be more than one hundred gigabytes (e.g., or even a terabyte or more). Loading such large seismic volumes, and analyzing them, can be considered a high-performance computing (HPC) task. As mentioned, loading of a seismic volume or seismic volumes can affect user experience where there is beyond a reasonable delay for loading.

As an example, a method can improve user experience through intelligent loading. As explained, one or more types of approaches may be utilized for intelligent loading that can include determining a loading order (e.g., loading priority, etc.).

Performant and efficient visualization of 3D seismic datasets can be a vital aspect of numerous subsurface processing, interpretation and modelling workflows supporting discovery, analysis and prospecting of subsurface geology. Such datasets tend to be both numerous in quantity and ever increasing in their size typically, on the order of gigabytes to terabytes per individual dataset. Traditional seismic rendering techniques tend to utilize a series of vertical and horizontal planes, fixed to an orthogonal survey geometry (inline xline and timeslice), with each individual data volume requiring its own individual set of intersection planes to enable visualization of seismic images. Whilst relatively efficient for easily accessing required data, fixed geometries rarely capture subsurface heterogeneity, and pose several imitations when arbitrary interrogation of data is required.

As explained with respect to the method 600, particularly the visualization 620, another way of viewing the data is to apply a level transparency to some selected values and render the dataset as a volume with depth (see, e.g., the histogram 622). Such an approach can be technically challenging and demand use of graphics hardware and associated technology.

As an example, a method such as the method 600 of FIG. 6 can be expedited through use of technologies involving graphics processing unit (GPUs) and shaders.

As an example, a method may include adjusting one or more parameters with respect to a histogram and dynamically rendering a visualization responsive to the adjusting. As an example, a graphical user interface may be operable interactively in real-time or near real-time via one or more human input devices (HIDs) such that an interpretation process and/or one or more other process associated with seismic data may be improved. As an example, a method may employ one or more techniques, technologies, etc., that may be available via a visualization framework. For example, consider a framework that may provide for implementation of shader techniques and/or technologies using various processors (e.g., one or more CPUs, one or more GPUs, etc.).

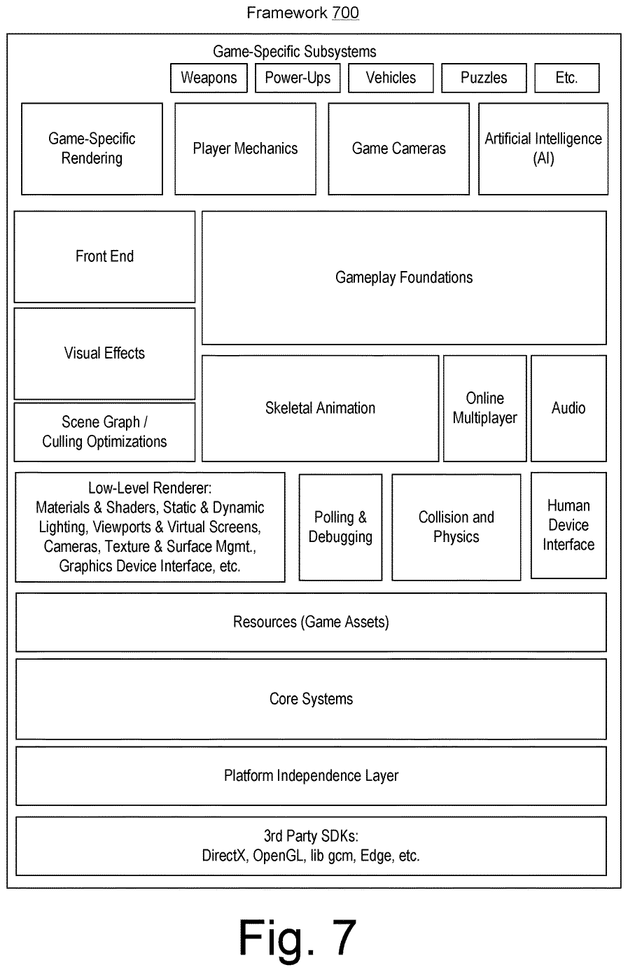

FIG. 7 shows an example of a framework 700 that includes various features, including, for example, shader features and texture features. The framework 700 includes various features of the Unity gaming framework (Unity Technologies, San Francisco, California). As shown, the framework 700 includes renderer features, including cameras, textures, shaders, etc. As an example, the framework 700 may be referred to as a visualization framework.

As an example, one or more features of one or more frameworks may be utilized. For example, consider the DIRECT3D framework (Microsoft Corporation, Redmond, Washington), which is a graphics application programming interface (API). Such a framework can use hardware acceleration if it is available on a graphics card, allowing for hardware acceleration of a 3D rendering pipeline. The DIRECT 3D framework exposes advanced graphics capabilities of 3D graphics hardware, including Z-buffering, W-buffering, stencil buffering, spatial anti-aliasing, alpha blending, color blending, mipmapping, texture blending, clipping, culling, atmospheric effects, perspective-correct texture mapping, programmable high-level shader language (HLSL) shaders and effects. As an example, high level and/or low level shaders may be utilized as part of a graphics hardware platform.

In computer graphics, a shader can be a computer program that computes appropriate levels of light, darkness, and color during rendering of a 3D scene (e.g., a process known as shading). Shaders can be customized to perform one or more of a variety of specialized functions in computer graphics, for example, in conjunction with GPUs. Shaders may be programmable using one or more shading languages, which can effectively program a GPU rendering pipeline. As an example, position and color (e.g., hue, saturation, brightness, and contrast) of all pixels, vertices, and/or textures used to construct a final rendered image can be altered using algorithms defined in a shader (e.g., shader techniques, etc.).

As an example, by using GPUs and a framework, generation of visualizations can be expedited, which, in turn, can improve seismic data workflows such as, for example, seismic interpretation workflows. In various examples, performance can exceed traditional seismic visualization in terms of scalability and performance.

As an example, a seismic rendering technique can include utilizing a brick approach, which may provide for expedited rendering, particularly for visualizations such as the visualization 620 of FIG. 6; noting that such a visualization may be combined with one or more slices (e.g., planes) that include a fuller range of values, for example, to provide some amount of context to structures rendered using a lesser range or ranges (e.g., one or more tails or a portion or portions thereof) of values of a histogram.

Seismic volume visualization can be performed using various components, which may operate independent of one another. Consider seismic data organized in a brick structure where such bricks exist in various resolutions. For example, a highest resolution can be raw post-stack seismic samples and lower resolutions can represent averaged samples where, for example, 8 samples in a previous resolution can be merged. Such a hierarchy of data where the full resolution representation of data bricks are “leaf nodes” and the internal and root node are averaged data at lower resolution may be called an octree. An octree is a tree data structure in which each internal node has exactly eight children. Octrees may be utilized to partition a three-dimensional space by recursively subdividing it into eight octants.

As an example, a seismic volume can be assigned a volume box in 3 dimensions where a challenge can exist to render these samples in a 3-dimensional scene (e.g., to a 2D display, etc.) in a way that lets a user interact with and explore the data. In such an example, loading the data onto graphics hardware and rendering it on the screen can be a time and memory consuming process, especially for volumes that reach terabytes in size. In various instances, a criterion may demand an ability to render at least 10 frames (screen images) per second to keep a software application interactive (e.g., consider the method 600 of FIG. 6 as being implemented in an interactive manner responsive to receipt of one or more of data, user input, etc.).

Using graphics hardware, a method can render a seismic volume using a technique called ray marching, and various pieces of the volume (e.g., level of detail (LOD) bricks), which can be rendered in different resolution (e.g., multi-resolution). Such an approach can be utilized in combination with a data and memory backend utilizing a texture management system, for example, consider a texture management system of the VULKAN framework (The Khronos Group Inc.), which is a visualization framework that may be utilized for one or more purposes. As an example, use of a texture management system can allow for a substantial increase in speed and details while dynamically updating a rendered view. As an example, such an approach can allow a geophysicist to browse through a seismic volume with more interactivity and better resolution. For example, consider a geophysicist that may be tasked with interpretation and/or quality control as to a geologic region surveyed using reflection seismology. In such an example, the geophysicist may interact with a graphical user interface where utilization of a framework that can provide for brick-based data access and rendering features that can provide a high-level of responsiveness in rendering visualizations to a display can expedite performance of a geophysicist's task or tasks. As explained, seismic data may provide a basis for model building, which may provide a basis for simulations and/or one or more other tasks. Where a framework expedites rendering of visualizations, seismic data may be assessed in a shorter period of time and/or may be assessed more thoroughly in a given amount of time where the former may increase throughput as to assessments and the latter may increase quality of assessments. As an example, where one or more quality control processes are to be performed as part of one or more workflows, expedited rendering of visualizations using an interactive graphical user interface or graphical user interfaces may provide for reduced user stress, higher throughput and improved quality and/or spotting of quality issues.

As to ray marching, it can be performed as an image-based volume rendering technique. For example, it may compute 2D images from 3D volumetric data sets (3D scalar fields).

As an example, a framework such as the UNITY 3D framework may be utilized for its rendering capabilities and to plug-in a customized low level data management system for seismic data access and caching. The UNITY 3D framework supports various graphics APIs (e.g., DIRECTX, METAL, OPENGL, VULKAN, etc.). The UNITY 3D framework can use a built-in set of graphics APIs and/or one or more other graphics APIs. The UNITY 3D framework and various other frameworks may be referred to as visualization frameworks and/or include various visualization framework features.

As an example, a framework, which may be a customized framework, can provide for efficiently loading seismic volume data from one or more sources and efficiently rendering one or more visualizations as a semi-transparent volume to a display (e.g., computer screen, etc.).

As an example, graphics hardware can be instructed to perform a render step to evaluate which level of detail (LOD) is required for each part of a visual volume. This information can then be queried by, for example, a processor, where requests for volume data are sent to a remote data storage using, for example, the OPENZGY framework (see, e.g., OSDU group of open-source projects, which includes an OPENZGY software development toolkit (SDK)). As explained, a framework may operate with respect to compressed and/or uncompressed data where, for example, decompression may be performed at one or more points (e.g., locally and/or remotely). As an example, decompression may be performed at a point (e.g., a location) that may depend on resources (e.g., compute power, memory, bandwidth, etc.). As an example, when data for required parts of a volume arrive, they can be uploaded to one or more GPUs and stored in an octree structure. The octree structure can then be utilized to create a sparse 3D texture, which can be shared with one or more graphics components of a framework (e.g., consider one or more graphics components of the UNITY 3D framework).

As explained, a framework may utilize associated libraries and/or libraries from one or more other sources. For example, consider the UNITY 3D framework as supporting various features of the VULKAN framework. As an example, inside a graphics framework, a shader language (e.g., an algorithm running on graphics hardware) can be utilized to query a sparse texture and perform a volume render step by using a ray marching technique.

In the UNITY 3D framework, sparse textures (also known as “tiled textures” or “mega-textures”) are textures that tend to be too large to fit in graphic memory in their entirety. To handle them, the UNITY 3D framework can break the main texture down into smaller rectangular sections known as “tiles”. Individual tiles can then be loaded as necessary. For example, if a camera can only see a small area of a sparse texture, then only the tiles that are currently visible need to be in memory. Aside from the tiling, a sparse texture can behave like other textures in usage. As an example, shaders can use them without special modification and they can have mipmaps, use all texture filtering modes, etc. If a particular tile cannot be loaded for one or more reasons, then the result can be undefined (e.g., some GPUs may show a black area where the missing tile should be).

As an example, a process that can be implemented for volume rendering can commence by placing a 3D box enveloping a seismic volume in a 3D scene as rendered to a display. In such an example, the box will hold the volume rendered result whenever the rendering is complete. Next, the process can determine in what resolution the volume should be rendered. As most actual seismic volumes are too large to fit into graphics memory, a process can split a seismic volume into bricks and determine for each brick what level of detail (LOD) it needs. Such an approach can consider that the number of voxels in a seismic volume can be large (e.g., 1000×1000×1000=1000000000 individual samples) while the number of pixels on a 4K computer monitor can be limited to about 8 million. As no pixel can have more than a single color (e.g., or grayscale), a process may limit the need for graphics memory if it is possible to determine exactly what is needed when rendering commenced and no transparency was used. Unfortunately, one single pixel can hold the average of several voxels and voxels can have transparency (e.g., or opacity) ranging from completely transparent to completely opaque. Accordingly, a process may have to load much more of the volume into the graphics memory to allow scalable and performant volume rendering.

As an example, volume rendering can commence by determining what actual volume data are needed and in which resolution. By rendering a volume box with X, Y, and Z world position instead of the colors red, green, and blue, it becomes possible to use a graphics shader (e.g., an algorithm running on graphics hardware) to create an image with the location in world coordinates where a ray from a camera into the scene for each pixel will intersect the volume. In such an approach, a process can then render one more of such images with front face culling which can give the exact location where each of those rays will exit the volume. These two volumes provide, for each pixel in the rendered image, where to enter and where to exit the volume (e.g., in world space).

As an example, an entry image region and an exit image region can be passed to a subsequent shader that can determine which parts of the volume are in need and in which resolution.

As an example, a process can also provide a number of values to sample between a start position and an end position (e.g., an entry position and an exit position). In such an example, for each pixel in an image with the start position, if it is defined (e.g., if the ray from pixel position in the near camera plane into the scene parallel with the camera view vector actually intersects the volume box), the process can query the mip-level (minimum intensity pixel or mip) for each position between the start and the end (e.g., using the number of values to sample) from the graphics framework. As an example, the resulting values can be stored in a hash table and passed to a data access service.

As an example, a process can account for asynchronous loading of data. For example, as bricks of data come in asynchronously from a data access process, they can be uploaded to a GPU (or GPUs) and inserted into an appropriate octree structure. As an example, a brick in an octree can have 4 indices in addition to volume sample data, indices I, J and K and a LOD (level of detail) level. As an example, the actual data can be accessed using shader code (e.g., an algorithm running on graphics hardware) through a data structure such as a sparse texture in 3D. In such an example, the sparse texture can be an abstract virtual representation of a traditional texture which will allow a sampler structure to query a voxel with a 3D index (e.g., a process can refer to a 3D index as a structure with 3 values I, J and K where for instance index 0, 0, 0 will represent the voxel (and seismic volume sample) at index 0, 0, 0). In such an example, the sparse texture allows software to specify a size for the entire volume without actually allocating computer memory for it, which conserves on memory demands. In such an example, as the seismic values arrive from the one or more data stores, the part of the sparse texture representing a brick in the octree can be allocated and assigned with the arrived values. As an example, a process can utilize a customized low level octree structure to map queries for samples to a node and value in the octree.

As an example, a sparse texture can be utilized together with start and stop images (e.g., entry and exit) in the same way that brick requests are generated. For example, for each pixel in an image with a start position, if it is defined, a process can look-up the sample value in a color table with transparency values (e.g., or opacity values) for each color (see, e.g., the histograms 612 and 622 of FIG. 6) and accumulate the colors for each sample along with the transparency (e.g., given by the color table). In such an approach, a factor may be utilized for early return if the accumulated transparency is below a certain threshold (e.g., or using opacity). As an example, a threshold may be set by default, automatically and/or be user selectable and/or adjustable. In various examples, opacity and transparency can be interchangeable in that each can characterize to what extent visibility exists (e.g., from a perspective of opaque or from a perspective of transparent).

As an example, a process can generate a result as a visualization rendered to a display of a particular number of pixels where, as the visualization fills in during data access (e.g., as appropriate with the particular number of pixels), a final result can be a final volume rendered image of seismic data. While such a result may be a desired result of a user, a user may aim to alter one or more conditions prior to rendering of a final result or after rendering of the final result where the alteration concerns the same seismic data (e.g., the same seismic volume) and/or one or more additional sets of seismic data (e.g., from another survey, another data store, etc.). Where an alteration is made, a framework can receive a request for alteration. In response, a procedure can be repeated. As explained, a framework may provide for dynamic rendering during data access where such a dynamic process may be interrupted and/or otherwise altered, for example, responsive to receipt of one or more instructions via interactions with a graphical user interface (GUI) that may include a rendering pane or rendering panes for one or more visualizations.

As an example, a procedure can be repeated whenever a camera is moved (e.g., responsive to user interaction); noting that the actual brick data can be cached in GPU and CPU memory for later access as long as there are free resources. When space is running low, a process can replace the bricks with the longest timestamp since last requested. Thus, a framework may provide for memory management according to one or more criteria (e.g., a change in a seismic dataset may act to purge or replace, a timestamp may provide for queuing replacement, etc.). As an example, a framework may provide for management of memory and/or one or more other resources whether local and/or remote.

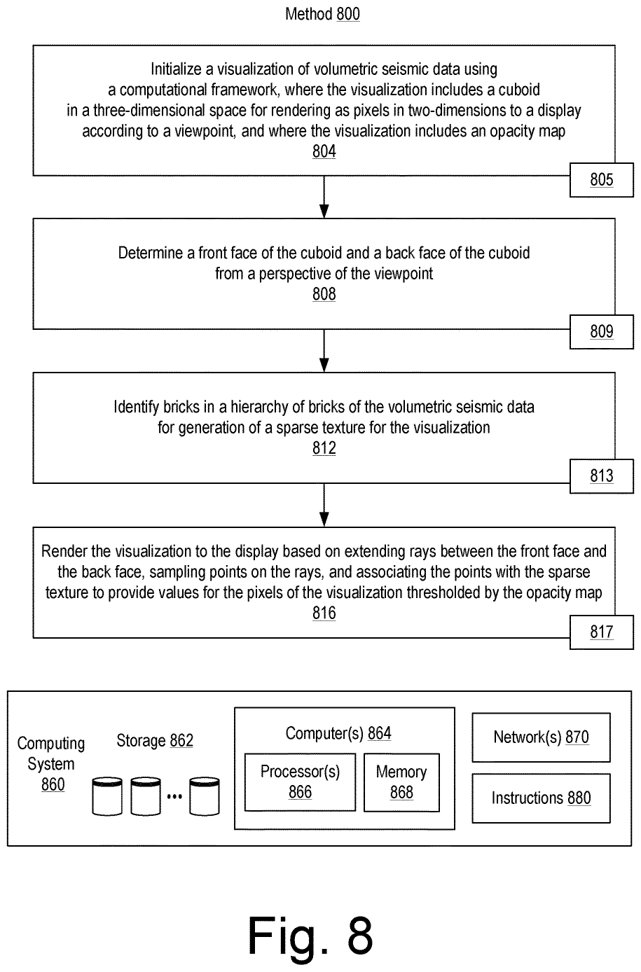

FIG. 8 shows an example of a method 800 that can include an initialization block 804 for initializing a visualization of volumetric seismic data using a computational framework, where the visualization includes a cuboid in a three-dimensional space for rendering as pixels in two-dimensions to a display according to a viewpoint, and where the visualization includes an opacity map; a determination block 808 for determining a front face of the cuboid and a back face of the cuboid from a perspective of the viewpoint; an identification block 812 for identifying bricks in a hierarchy of bricks of the volumetric seismic data for generation of a sparse texture for the visualization; and a render block 816 for rendering the visualization to the display based on extending rays between the front face and the back face, sampling points on the rays, and associating the points with the sparse texture to provide values for the pixels of the visualization according to the opacity map.

As an example, a method can include an initialization block for setting up a scene and volume box and providing a color table and opacity map; a determination block for determining a volume box front face (FF) and outputting position XYZ rather than color RGB and for determining a volume box back face (BF) and outputting position XYZ rather than color RGB; an identification block for identifying bricks in an octree for rendering a volume using multiple render targets where identified brick IDs are to be written to an output texture (e.g., a sparse texture); and a render block for, for each pixel of a visualization to render to a display, shooting a ray from the FF to the BF, where, for n number of sampled points XYZ on the ray, checking a needed level of detail (LOD) for each fragment above an opacity threshold, where if the brick at a requested level exists for XYZ, sampling data from the output texture (e.g., a sparse texture) and accumulating color and opacity (e.g., or transparency); otherwise, sampling data from the output texture (e.g., a sparse texture) using a brick at lower level of detail (LOD) and accumulating color and opacity (e.g., or transparency). In such an example, values for pixels can be determined for the visualization to be rendered to a display. In such an example, the level of detail may be dynamically adjusted, for example, as more bricks of seismic data are accessed.

As an example, a method may be represented in outline form, for example, as pseudo-code:
1. Set up scene and volume box and provide a color table and an opacity map;
2. Render a volume box front face (FF). Output position XYZ instead of color RGB;
3. Render a volume box back face (BF). Output position XYZ instead of color RGB;
   #figure out bricks in octree AND render volume using multiple render targets
   #brick IDs will be written to an output texture in step 4.2.1
4. For each pixel:
   4.1 Send a ray from FF to BF;
   4.2 For n number of sampled points XYZ on ray;
      4.2.1 Check needed level of detail (LOD) for each fragment above an opacity threshold;
      if brick at requested level exist for XYZ;
      4.2.2 sample data from sparse texture and accumulate color and opacity (e.g., or transparency);
      else
      4.2.3 sample data from sparse texture using a brick at lower detail and accumulate color and opacity (e.g., or transparency).

The method 800 is shown in FIG. 8 in association with various computer-readable media (CRM) blocks 805, 809, 813 and 817. Such blocks generally include instructions suitable for execution by one or more processors (or cores) to instruct a computing device or system to perform one or more actions. While various blocks are shown, a single medium may be configured with instructions to allow for, at least in part, performance of various actions of the method 800 (e.g., using the computing system 860, etc.). A computer-readable medium (CRM) may be a computer-readable storage medium that is not a carrier wave, that is not a signal and that is non-transitory.

FIG. 8 shows the computing system 860 as including one or more information storage devices 862, one or more computers 864, one or more network interfaces 870 and instructions 880. As to the one or more computers 864, each computer may include one or more processors (or processing cores) 866 and memory 868 for storing instructions executable by at least one of the one or more processors. A computer may include one or more network interfaces (wired or wireless), one or more graphics cards, a display interface (wired or wireless), etc. A system may include one or more display devices (optionally as part of a computing device, etc.). Memory can be a computer-readable storage medium. A computer-readable storage medium includes, but is not limited to, a carrier wave, a signal, and a non-transitory medium.

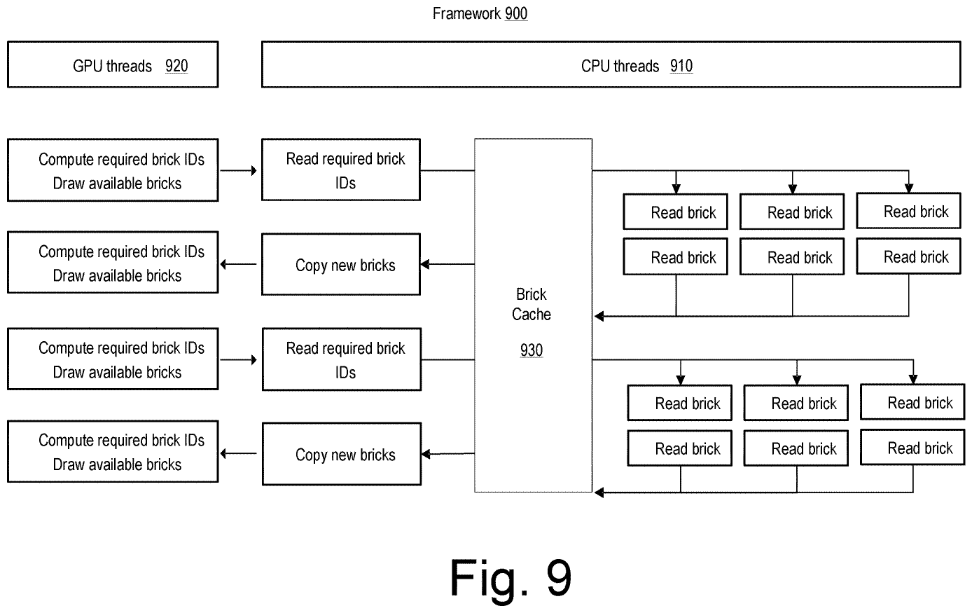

FIG. 9 shows an example of a framework 900 that can be implemented to perform one or more of the actions of the method 800 of FIG. 8 and/or one or more other actions. As shown, the framework 900 includes CPU threads 910, GPU threads 920 and a brick cache 930. Various actions can occur using the CPU threads 910 and the brick cache 930 where interactions exist with the GPU threads 920. As shown, the framework 900 can perform an interactive process where various actions can be occurring to generate a visualization. The framework 900 provides for scalability and efficiency management of memory in generating a visualization, which may be generated using such resources to make the framework 900 interactive for a user (e.g., before a display operatively coupled to the framework 900). As explained, a user performing a seismic workflow may desire a high level of flexibility and interactivity between features and rendering of visualization to enhance the user's ability to discern (e.g., interpret) structures in a geologic region and/or to perform one or more other tasks.

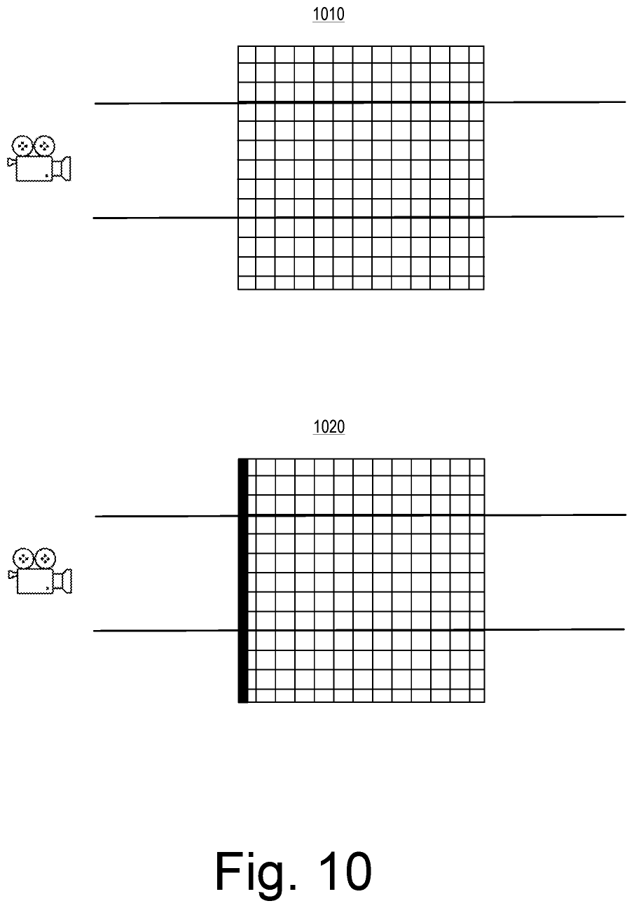

FIG. 10 shows an example of processes 1010 and 1020 as to setting up a volume and determining a front face (FF), respectively, for example, based on a particular camera view (e.g., camera position in a 3D space, which may be referred to as a viewpoint from which a face may be determined). As to the process 1010, it can include representing a 3D volume box (e.g., a cuboid) in 2D and a user-controlled camera with, for example, an orthographic projection (see, e.g., black lines). In such an example, voxels inside the 3D volume box represent volume sample values, which may be structured in a hierarchy, for example, as bricks (e.g., consider an octree structure). As to the process 1020, it can include rendering or determining a front face (e.g., thick black line) to get volume start positions for each pixel to be rendered to a display.

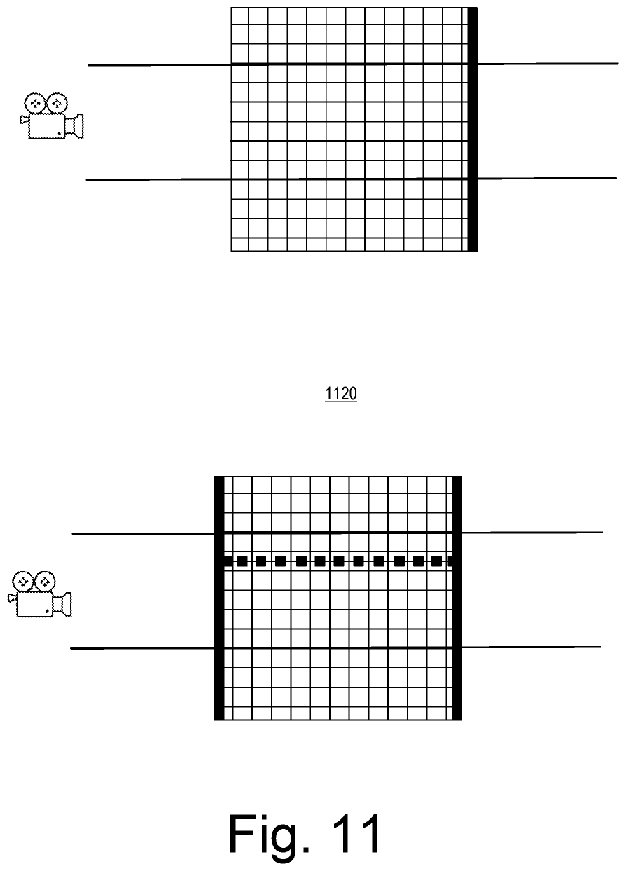

FIG. 11 shows an example of processes 1110 and 1120 as to determining a back face (BF) and marching along a ray between the front face (FF) and the back face (BF), respectively, for example, based on a particular camera view (e.g., camera position in a 3D space). As to the process 1110, it can include rendering or determining a back face (e.g., thick black line) to get volume end positions for each pixel to be rendered to a display. As to the process 1120, it can include, for each pixel, accumulating sample values and transparency values (e.g., or opacity values) between start positions and end positions. As an example, if not using transparency, a process may return a first value between start and end. In the example of FIG. 11, a line in the graphic of the process 1120 represents rendering of one pixel (e.g., via sampling of multiple volume values).

As explained, on graphics hardware (e.g., one or more GPUs) a method can evaluate which level of detail (LOD) is needed for each part of a visual volume. This information can then be queried by a CPU where requests for volume data can be transmitted to a data storage (e.g., remote) using, for example, the OPENZGY framework. When data for the required parts of the volume arrive, these data can be uploaded to the one or more GPUs and stored in an octree structure.

This octree structure can then be used to create a sparse 3D texture that can be shared with a framework such as, for example, the UNITY 3D framework. As explained, a shader can be executed to query the sparse 3D texture to perform a volume render action that can utilize ray marching.

As explained, a sparse texture can be a texture that is too large to fit in graphic memory in its entirety. For example, a large texture space can be broken down into smaller rectangular sections (e.g., tiles) where individual tiles can then be loaded as appropriate, optionally dynamically responsive to availability of data, a change in a visualization, etc.

In the VULKAN framework, sparse residency can be implemented, for example, for mega-textures (e.g., or megatextures). As an example, a method may include use of VkPhysicalDeviceFeatures::sparseResidencyBuffer—for buffers, sparseResidencyImage2D, sparseResidencyImage3D, sparseResidency2Samples and for images. As an example, a resource can be “partially resident” (e.g., not all pages of a resource must be bound to actual memory before it is usable on a GPU). As an example, images can be bound based on extents expressed in pixels (width, height, depth) instead of linear memory pages measured in bytes. As an example, a large texture (e.g., a megatexture) can be created where data can be dynamically streamed in and out of video memory for parts that are needed.

The VULKAN framework provides features for sparse partially-resident images to manage residency at either image subresource or sparse image block granularity. For example, each image subresource (e.g., outside of the mip tail) can start on a sparse block boundary with dimensions that are integer multiples of the corresponding dimensions of the sparse image block. An application can use such types of images to control LOD based on total memory consumption. For example, if memory pressure becomes an issue, an application can unbind and disable specific mipmap levels of images without having to recreate resources or modify texel data of unaffected levels. Such functionality can also be used to access subregions of an image in a “megatexture” fashion. For example, an application can create a large image and only populate the region of the image that is currently being used in the scene.

As explained, a large texture can be broken into tiles as part of a sparse texture process where tiles may be associated with a hierarchical data structure (e.g., bricks in octrees, etc.). As an example, dynamic loading and rendering may be performed where, for example, level of detail (LOD) rendering dynamically increases responsive to dynamic loading.

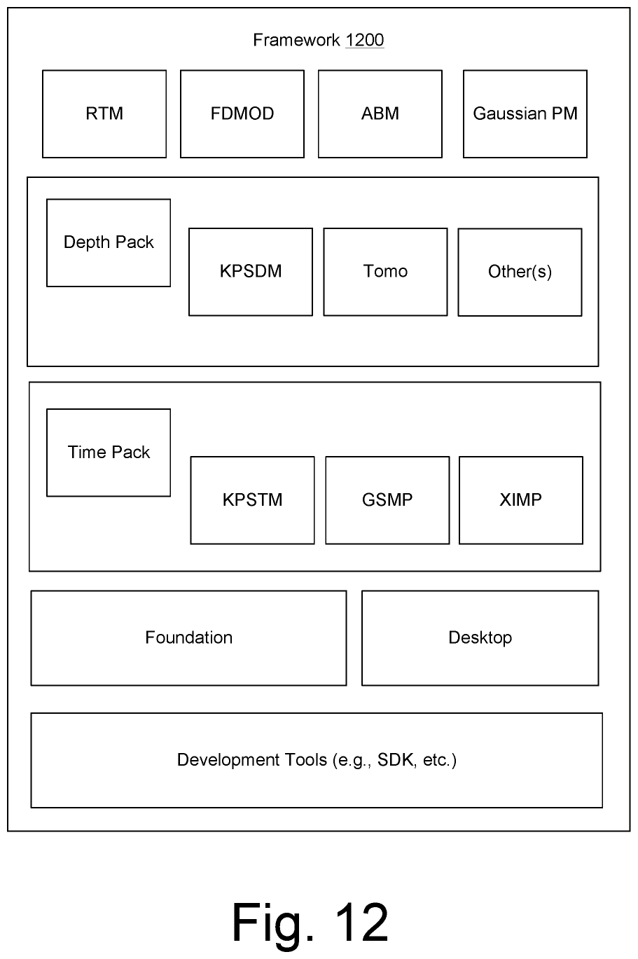

FIG. 12 shows an example of a computational framework 1200 that can include one or more processors and memory, as well as, for example, one or more interfaces. The blocks of the computational framework 1200 may be provided as instructions such as the instructions 880 of the system 860 of FIG. 8, etc. The computational framework of FIG. 12 can include one or more features of the OMEGA framework, which includes finite difference modelling (FDMOD) features for two-way wavefield extrapolation modelling, generating synthetic shot gathers with and without multiples. The FDMOD features can generate synthetic shot gathers by using full 3D, two-way wavefield extrapolation modelling, which can utilize wavefield extrapolation logic matches that are used by reverse-time migration (RTM). A model may be specified on a dense 3D grid as velocity and optionally as anisotropy, dip, and variable density.

As shown in FIG. 12, the computational framework 1200 includes features for RTM, FDMOD, adaptive beam migration (ABM), Gaussian packet migration (Gaussian PM), depth processing (e.g., Kirchhoff prestack depth migration (KPSDM), tomography (Tomo)), time processing (e.g., Kirchhoff prestack time migration (KPSTM), general surface multiple prediction (GSMP), extended interbed multiple prediction (XIMP)), framework foundation features, desktop features (e.g., GUIs, etc.), and development tools.

The framework 1200 can include features for geophysics data processing. The framework 1200 can allow for processing various types of data such as, for example, one or more of: land, marine, and transition zone data; time and depth data; 2D, 3D, and 4D surveys; isotropic and anisotropic (TTI and VTI) velocity fields; and multicomponent data.

The framework 1200 can allow for transforming seismic, electromagnetic, microseismic, and/or vertical seismic profile (VSP) data into actionable information, for example, to perform one or more actions in the field for purposes of resource production, etc. The framework 1200 can extend workflows into reservoir characterization and earth modelling. For example, the framework 1200 can extend geophysics data processing into reservoir modelling by integrating with the PETREL framework via the Earth Model Building (EMB) tools, which enable a variety of depth imaging workflows, including model building, editing and updating, depth-tomography QC, residual moveout analysis, and volumetric common-image-point (CIP) pick QC. Such functionalities, in conjunction with depth tomography and migration algorithms of the framework 1200 can produce accurate and precise images of the subsurface. The framework 1200 may provide support for field to final imaging, to prestack seismic interpretation and quantitative interpretation, from exploration to development.

As an example, the FDMOD component can be instantiated via one or more CPUs and/or one or more GPUs for one or more purposes. For example, consider utilizing the FDMOD for generating synthetic shot gathers by using full 3D, two-way wavefield extrapolation modelling, the same wavefield extrapolation logic matches that are used by RTM. FDMOD can model various aspects and effects of wave propagation. The output from FDMOD can be or include synthetic shot gathers including direct arrivals, primaries, surface multiples, and interbed multiples. The model can be specified on a dense 3D grid as velocity and optionally as anisotropy, dip, and variable density. As an example, survey designs can be modelled to ensure quality of a seismic survey, which may account for structural complexity of the model. Such an approach can enable evaluation of how well a target zone will be illuminated. Such an approach may be part of a quality control process (e.g., task) as part of a seismic workflow. As an example, a FDMOD approach may be specified as to size, which may be model size (e.g., a grid cell model size). Such a parameter can be utilized in determining resources to be allocated to perform a FDMOD related processing task. For example, a relationship between model size and CPUs, GPUs, etc., may be established for purposes of generating results in a desired amount of time, which may be part of a plan (e.g., a schedule) for a seismic interpretation workflow.

As an example, as survey data become available, interpretation tasks may be performed for building, adjusting, etc., one or more models of a geologic environment. For example, consider a vessel that transmits a portion of acquired data while at sea and that transmits a portion of acquired data while in port, which may include physically offloading one or more storage devices and transporting such one or more storage devices to an onshore site that includes equipment operatively coupled to one or more networks (e.g., cable, etc.). As data are available, options exist for tasks to be performed.

As an example, the framework 1200 can include one or more sets of instructions executable to perform one or more methods such as, for example, the method 800, etc.

As an example, a method can include initializing a visualization of volumetric seismic data using a computational framework, where the visualization includes a cuboid in a three-dimensional space for rendering as pixels in two-dimensions to a display according to a viewpoint, and where the visualization includes an opacity map (e.g., an associated opacity map, which may be a transparency map); determining a front face of the cuboid and a back face of the cuboid from a perspective of the viewpoint; identifying bricks in a hierarchy of bricks of the volumetric seismic data for generation of a sparse texture for the visualization; and rendering the visualization to the display based on extending rays between the front face and the back face, sampling points on the rays, and associating the points with the sparse texture to provide values for the pixels of the visualization thresholded by the opacity map. In such an example, the hierarchy of bricks can include octrees.

As an example, an opacity map can specify opacity levels (e.g., or transparency levels) for a histogram of values of voxels in a volumetric seismic data.

As an example, a method can include rendering that dynamically adjusts a level of detail of a visualization responsive to accessing additional bricks (e.g., additional data), where, for example, the accessing can include storing bricks in a brick memory cache.

As an example, a sparse texture can be generated using one or more graphics processing units. In such an example, a reference to the sparse texture can be passed to one or more shaders.

As an example, a method can include rendering in a manner that accounts for a pixel resolution of the display. For example, memory utilization and/or accessing of hierarchically structured data may be performed in a manner that depends on how many pixels are in a display.

As an example, an opacity map can include a non-opaque, transparent region disposed between two opaque regions. In such an example, the two opaque regions may correspond to histogram values of volumetric seismic data for negative seismic trace amplitudes and positive seismic trace amplitudes. Such amplitudes may be associated with an event, which may be a reflector in a subsurface geologic environment.

As an example, a memory size of volumetric seismic data may exceed 50 gigabytes. As an example, a memory size of volumetric seismic data may exceed 1 terabyte or more than several terabytes.

As an example, a method can include receiving an instruction to alter a viewpoint and repeating determining, identifying and rendering for the altered viewpoint. As an example, a viewpoint may correspond to a camera positionable in a graphical user interface rendered to a display. In such an example, determining, identifying and rendering can respond automatically to a change in a position of the camera.

As an example, rendering can increase a level of detail of a visualization responsive to accessing additional bricks (e.g., seismic data as may be hierarchically structured).

As an example, a sparse texture can include an associated size for a cuboid, where memory allocation for rendering a visualization is for a fraction of the size of the cuboid.

As an example, a method can utilize a GPU-based shader that can query a sparse texture using a 3D index.

As an example, as a portion of a volumetric seismic data arrives from a remote data source, a portion of a sparse texture representing one of the bricks in an octree of the hierarchy can be allocated and assigned with the portion of the volumetric seismic data.

As an example, a system can include a processor; memory operatively coupled to the processor; and processor-executable instructions stored in the memory to instruct the system to: initialize a visualization of volumetric seismic data using a computational framework, where the visualization includes a cuboid in a three-dimensional space for rendering as pixels in two-dimensions to a display according to a viewpoint, and where the visualization includes an opacity map; determine a front face of the cuboid and a back face of the cuboid from a perspective of the viewpoint; identify bricks in a hierarchy of bricks of the volumetric seismic data for generation of a sparse texture for the visualization; and render the visualization to the display based on extension of rays between the front face and the back face, sampling points on the rays, and association of the points with the sparse texture to provide values for the pixels of the visualization thresholded by the opacity map.

As an example, one or more computer-readable storage media can include computer-executable instructions executable to instruct a computing system to: initialize a visualization of volumetric seismic data using a computational framework, where the visualization includes a cuboid in a three-dimensional space for rendering as pixels in two-dimensions to a display according to a viewpoint, and where the visualization includes an opacity map; determine a front face of the cuboid and a back face of the cuboid from a perspective of the viewpoint; identify bricks in a hierarchy of bricks of the volumetric seismic data for generation of a sparse texture for the visualization; and render the visualization to the display based on extension of rays between the front face and the back face, sampling points on the rays, and association of the points with the sparse texture to provide values for the pixels of the visualization thresholded by the opacity map.

As an example, a computer program product can include computer-executable instructions to instruct a computing system to perform a method, for example, consider a method such as the method 800 of FIG. 8, etc.

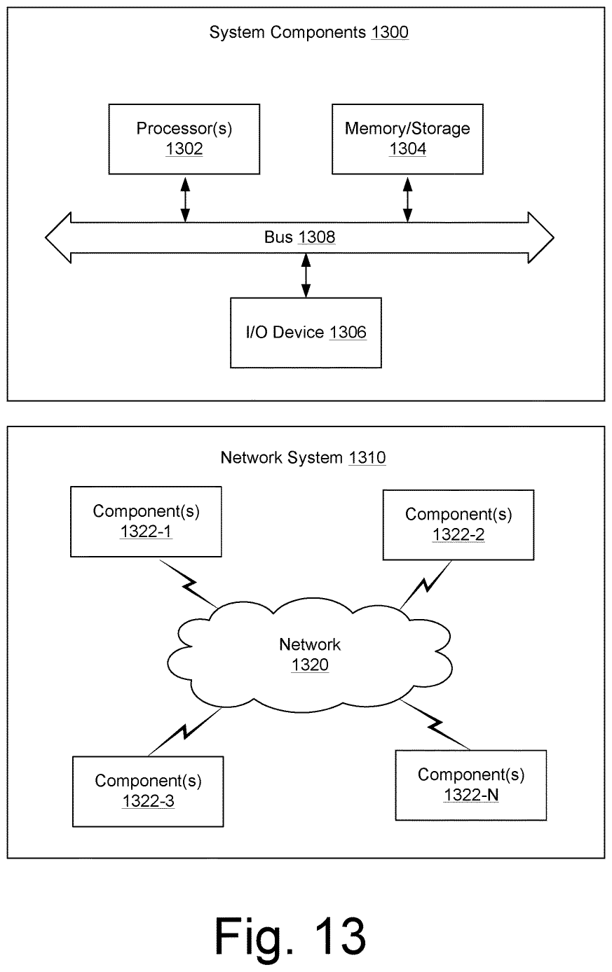

FIG. 13 shows components of a computing system 1300 and a networked system 1310 that includes a network 1320. The system 1300 includes one or more processors 1302, memory and/or storage components 1304, one or more input and/or output devices 1306 and a bus 1308. Instructions may be stored in one or more computer-readable media (memory/storage components 1304). Such instructions may be read by one or more processors (see the processor(s) 1302) via a communication bus (see the bus 1308), which may be wired or wireless. The one or more processors may execute such instructions to implement (wholly or in part) one or more attributes (as part of a method). A user may view output from and interact with a process via an I/O device (see the device 1306). A computer-readable medium may be a storage component such as a physical memory storage device such as a chip, a chip on a package, a memory card, etc. (a computer-readable storage medium).

Components may be distributed, such as in the network system 1310. The network system 1310 includes components 1322-1, 1322-2, 1322-3, . . . 1322-N. The components 1322-1 may include the processor(s) 1302 while the component(s) 1322-3 may include memory accessible by the processor(s) 1302. Further, the component(s) 1322-2 may include an I/O device for display and optionally interaction with a method. The network may be or include the Internet, an intranet, a cellular network, a satellite network, etc.

A device may be a mobile device that includes one or more network interfaces for communication of information. A mobile device may include a wireless network interface (operable via IEEE 802.11, ETSI GSM, BLUETOOTH®, satellite, etc.). A mobile device may include components such as a main processor, memory, a display, display graphics circuitry (optionally including touch and gesture circuitry), a SIM slot, audio/video circuitry, motion processing circuitry (accelerometer, gyroscope), wireless LAN circuitry, smart card circuitry, transmitter circuitry, GPS circuitry, and a battery. A mobile device may be configured as a cell phone, a tablet, etc. A method may be implemented (wholly or in part) using a mobile device. A system may include one or more mobile devices.

A system may be a distributed environment such as a so-called “cloud” environment where various devices, components, etc. interact for purposes of data storage, communications, computing, etc. A device or a system may include one or more components for communication of information via one or more of the Internet (where communication occurs via one or more Internet protocols), a cellular network, a satellite network, etc. A method may be implemented in a distributed environment (wholly or in part as a cloud-based service).

Information may be input from a display (consider a touchscreen), output to a display or both. Information may be output to a projector, a laser device, a printer, etc. such that the information may be viewed. Information may be output stereographically or holographically. As to a printer, consider a 2D or a 3D printer. A 3D printer may include one or more substances that can be output to construct a 3D object. Data may be provided to a 3D printer to construct a 3D representation of a subterranean formation. Layers may be constructed in 3D (horizons, etc.), geobodies constructed in 3D, etc. Holes, fractures, etc., may be constructed in 3D (as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
initializing a visualization of volumetric seismic data using a computational framework, wherein the visualization includes a cuboid in a three-dimensional space for rendering as pixels in two-dimensions to a display according to a viewpoint, and wherein the visualization includes an opacity map;
determining a front face of the cuboid and a back face of the cuboid from a perspective of the viewpoint;
identifying bricks in a hierarchy of bricks of the volumetric seismic data for generation of a sparse texture for the visualization; and
rendering the visualization to the display based on extending rays between the front face and the back face, sampling points on the rays, and associating the points with the sparse texture to provide values for the pixels of the visualization thresholded by the opacity map.

2. The method of claim 1, wherein the hierarchy of bricks includes octrees.

3. The method of claim 1, wherein the opacity map specifies opacity levels for a histogram of values of voxels in the volumetric seismic data.

4. The method of claim 1, wherein the rendering dynamically adjusts the level of detail of the visualization responsive to accessing additional bricks.

5. The method of claim 4, wherein the accessing includes storing bricks in a brick memory cache.

6. The method of claim 1, wherein the sparse texture is generated using one or more graphics processing units.

7. The method of claim 6, wherein a reference to the sparse texture is passed to one or more shaders.

8. The method of claim 1, wherein the rendering accounts for a pixel resolution of the display.

9. The method of claim 1, wherein the opacity map includes a non-opaque, transparent region disposed between two opaque regions.

10. The method of claim 9, wherein the two opaque regions correspond to histogram values of the volumetric seismic data for negative seismic trace amplitudes and positive seismic trace amplitudes.

11. The method of claim 1, wherein a memory size of the volumetric seismic data exceeds 50 gigabytes.

12. The method of claim 1, comprising receiving an instruction to alter the viewpoint and repeating the determining, the identifying and the rendering for the altered viewpoint.

13. The method of claim 1, wherein the viewpoint corresponds to a camera positionable in a graphical user interface rendered to the display.

14. The method of claim 13, wherein the determining, the identifying and the rendering respond automatically to a change in a position of the camera.

15. The method of claim 1, wherein the rendering increases the level of detail of the visualization responsive to accessing additional bricks.

16. The method of claim 1, wherein the sparse texture includes an associated size for the cuboid, wherein memory allocation for the rendering is for a fraction of the size of the cuboid.

17. The method of claim 1, wherein a GPU-based shader queries the sparse texture using a 3D index.

18. The method of claim 1, wherein as a portion of the volumetric seismic data arrives from a remote data source, a portion of the sparse texture representing one of the bricks in an octree of the hierarchy is allocated and assigned with the portion of the volumetric seismic data.

19. A system comprising:
a processor;
memory operatively coupled to the processor; and
processor-executable instructions stored in the memory to instruct the system to:
initialize a visualization of volumetric seismic data using a computational framework, wherein the visualization includes a cuboid in a three-dimensional space for rendering as pixels in two-dimensions to a display according to a viewpoint, and wherein the visualization includes an opacity map;
determine a front face of the cuboid and a back face of the cuboid from a perspective of the viewpoint;
identify bricks in a hierarchy of bricks of the volumetric seismic data for generation of a sparse texture for the visualization; and
render the visualization to the display based on extension of rays between the front face and the back face, sampling points on the rays, and association of the points with the sparse texture to provide values for the pixels of the visualization thresholded by the opacity map.

20. One or more computer-readable storage media including computer-executable instructions executable to instruct a computing system to:
initialize a visualization of volumetric seismic data using a computational framework, wherein the visualization includes a cuboid in a three-dimensional space for rendering as pixels in two-dimensions to a display according to a viewpoint, and wherein the visualization includes an opacity map;
determine a front face of the cuboid and a back face of the cuboid from a perspective of the viewpoint;
identify bricks in a hierarchy of bricks of the volumetric seismic data for generation of a sparse texture for the visualization; and
render the visualization to the display based on extension of rays between the front face and the back face, sampling points on the rays, and association of the points with the sparse texture to provide values for the pixels of the visualization thresholded by the opacity map.
